(19) United States
(12) Patent Application Publication
(10) Pub. No.: US 2015/0301726 A1
(43) Pub. Date: Oct. 22, 2015

(54) Systems and Methods for Displaying Free-Form Drawing on a Contact-Sensitive Display

(71) Applicant: Societe BIC, Clichy (FR)

(72) Inventors: Mathias Mattiuzzo, Vincennes (FR); Sylvain Giroudon, Montrouge (FR); Sebastien Bloc, Paris (FR); Lucas Yalap, Sarcelles (FR)

(21) Appl. No.: 14/686,869

(22) Filed: Apr. 15, 2015

Related U.S. Application Data
(60) Provisional application No. 61/980,127, filed on Apr. 16, 2014.
(60) Provisional application No. 62/062,315, filed on Oct. 10, 2014.

(51) Int. Cl. G06F 3/0484; G06F 3/041

(52) U.S. Cl. CPC G06F 3/04845; G06F 3/041; G06F 3/0416

(57) ABSTRACT

Systems and methods are provided for displaying free-form drawing on a contact-sensitive display. A new contact on the display is detected by a computer. A determination is made by the computer as to whether a width of the new contact is less than a maximum width. When the width of the new contact is less than the maximum width, the width of the new contact is compared to a width of other current contacts by the computer. When the width of the new contact is less than widths of all other current contacts, the new contact is tracked by the computer using a first data structure. A release of the new contact from the display is detected by the computer. Data associated with the new contact is transferred from the first data structure to the second data structure by the computer when the new contact is detected as being released.

### CROSS-REFERENCE TO RELATED APPLICATIONS

This application claims priority to U.S. Provisional Patent Application No. 61/980,127, filed Apr. 16, 2014, entitled “BIC Connect Educational System,” and to U.S. Provisional Patent Application No. 62/062,315, filed Oct. 10, 2014, entitled “Systems and Methods for Displaying Free-Form Drawing on a Contact-sensitive Display,” which are incorporated herein by reference in their entireties.

### FIELD

This disclosure is related generally to a contact-sensitive display and more particularly to display of free-form drawing on a contact-sensitive display.

### BACKGROUND

The rapid advancement of handheld electronics (e.g., cellular telephones, smart phones, tablet devices, laptops, combinations thereof, etc.) has helped to power the advancement of user interfaces and user interface controls. In recent years, contact-sensitive displays, where a user controls a device by contacting a display screen, have advanced significantly in popularity. Such devices operate, for example, using an array of sensors that detect changes in display screen capacitances at coordinates of the display screen caused by contact operations at those coordinates. Contact-sensitive screen displays provide a mechanism for free-form drawing (e.g., writing), such as via touches of a user's finger or stylus.

### SUMMARY

The present disclosure is directed to a computer-implemented method, system, and non-transitory computer-readable storage medium for displaying free-form drawing on a contact-sensitive display. In an example computer-implemented method for displaying free-form drawing on a contact-sensitive display, a new contact on a contact-sensitive display is detected by a computer. A determination is made by the computer as to whether a width of the new contact is less than a maximum width threshold. When the width of the new contact is less than the maximum width threshold, the width of the new contact is compared to a width of other current contacts by the computer. When the width of the new contact is less than widths of all other current contacts, the new contact is tracked by the computer using a first data structure. A release of the new contact from the contact-sensitive display is detected by the computer. Data associated with the new contact is transferred from the first data structure to the second data structure by the computer when the new contact is detected to have been released. Contact data stored in the first data structure and the second data structure are used by the computer to visualize drawing on the contact-sensitive display.

The computer-implemented method may further include declining, by the computer, to further track the new contact using the first data structure when the width of the new contact is not less than the maximum width threshold. The computer-implemented method may further include declining, by the computer, to further track the new contact using the first data structure when the width of the new contact is not less than widths of all the other current contacts. The computer-implemented method may further include (i) declining, by the computer, to further track the particular current contact using the first data structure when the width of the new contact is less than a width of a particular current contact, and (ii) removing, by the computer, tracking data associated with the particular current contact from the first data structure when the width of the new contact is less than the width of the particular current contact. In the computer-implemented method, the removing may comprise deleting or marking invalid. The computer-implemented method may further include updating, by the computer, the contact-sensitive display to remove visualization of the particular current contact when the tracking data associated with the particular current contact is removed.

The computer-implemented method may further include tracking, by the computer, the new current contact using the first data structure when comparing the width of the new contact to the width of other current contacts identifies no other current contacts. In the computer-implemented method, the contact-sensitive display may be a component of a cellular telephone, a smart phone, a tablet device, a laptop, or a combination thereof. In the computer-implemented method, the first data structure may be a first array for tracking unconfirmed contacts, and the second data structure may be a second array for tracking confirmed contacts. In the computer-implemented method, the contact-sensitive display may be configured to detect multiple contacts simultaneously. In the computer-implemented method, the contact-sensitive display may be configured to detect contacts from a contact or a stylus. The computer-implemented method may further include removing, by the computer, transferred data associated with the new contact from the first data structure after transferring. In the computer-implemented method, the new contact may be contact by a palm of a person.

An example system for displaying free-form drawing on a contact-sensitive display includes a contact-sensitive display configured to detect multiple contacts simultaneously. A first data structure stored on a non-transitory computer-readable medium is configured to store tracking data associated with unconfirmed contacts. A second data structure stored on the non-transitory computer-readable medium is configured to store tracking data associated with confirmed contacts. A processing system is configured to determine whether a new contact on the contact-sensitive display is a highest priority contact. When the new contact is determined by the processing system to be the highest priority contact, tracking data associated with the new contact is stored in the first data structure by the processing system, and tracking data associated with other contacts is removed from the first data structure by the processing system. When the new contact is released and remains the highest priority contact, the tracking data associated with the new contact is copied to the second data structure by the processing system. The contact-sensitive display is configured to visualize data stored in both the first data structure and the second data structure simultaneously.

Another example system for displaying free-form drawing on a contact-sensitive display includes a contact-sensitive display configured to detect multiple contacts simultaneously. A first data structure stored on a non-transitory computer-readable medium is configured to store tracking data associated with unconfirmed contacts. A second data structure stored on the non-transitory computer-readable medium is configured to store tracking data associated with confirmed contacts. A processing system is configured to execute steps. In executing the steps, a determination is made by the processing system as to whether a width of a new contact is less than a maximum width threshold. When the width of the new contact is determined by the processing system to be less than the maximum width threshold, the width of the new contact is compared to a width of other current contacts by the processing system. When the width of the new contact is determined by the processing system to be less than widths of all other current contacts, the new contact is tracked by the processing system using a first data structure. A release of the new contact from the contact-sensitive display is detected by the processing system. Data associated with the new contact is transferred from the first data structure to the second data structure by the processing system when the processing system detects that the new contact has been released. Contact data stored in the first data structure and the second data structure are used by the processing system to visualize drawing on the contact-sensitive display.

In the system, the steps performed by the processing system may include declining to further track the new contact using the first data structure when the width of the new contact is not less than the maximum width threshold. In the system, the steps performed by the processing system may include declining to further track the new contact using the first data structure when the width of the new contact is not less than widths of all the other current contacts. In the system, the steps performed by the processing system may include (i) declining to further track the particular current contact using the first data structure when the width of the new contact is less than a width of a particular current contact, and (ii) removing tracking data associated with the particular current contact from the first data structure when the width of the new contact is less than the width of the particular current contact. In the system, the steps performed by the processing system may include updating the contact-sensitive display to remove visualization of the particular current contact when the tracking data associated with the particular current contact is removed. In the system, the steps performed by the processing system may include tracking the new current contact using the first data structure when comparing the width of the new contact to the width of other current contacts identifies no other current contacts.

In another example computer-implemented method for displaying free-form drawing on a contact-sensitive display, a contact-sensitive display is used to sample, by the computer, coordinates of three consecutive points of a continuous contact operation. A first midpoint that is midway between a first point and a second point of the three consecutive points is identified by the computer. A second midpoint that is midway between the second point and a third point of the three consecutive points is identified by the computer. A curve from the first midpoint to the second midpoint is determined by the computer. The curve is drawn by the computer from the first midpoint to the second midpoint on the contact-sensitive display.

The computer-implemented method may further include (i) identifying, by the computer, a fourth point of the continuous contact operation, (ii) identifying, by the computer, a third midpoint that is midway between the third point and the fourth point of the three consecutive points, (iii) determining, by the computer, a second curve from the second midpoint to the third midpoint, and (iv) drawing, by the computer, the second curve from the second midpoint to the third midpoint on the contact-sensitive display. The computer-implemented method may further include identifying, by the computer, a fifth point of the continuous contact operation; determining, by the computer, a third curve from the third midpoint to the fifth point; and drawing, by the computer, the third curve from the third midpoint to the fifth point on the contact-sensitive display. In the computer-implemented method, the curve may be a Bezier curve. In the computer-implemented method, the curve may be a quadratic Bezier curve. In the computer-implemented method, the curve may be a second degree curve.

The computer-implemented method may further include drawing, by the computer, a line from the first point to the first midpoint. In the computer-implemented method, drawing the curve may comprise refreshing, by the computer, the contact-sensitive display in a first area, where the first area surrounds the first midpoint and the second midpoint, and where the first area is less than an entire area of the contact-sensitive display. The first area may be a minimized area that includes an entirety of the curve. In the computer-implemented method, the sampling of the coordinates of three consecutive points may include detecting, by the computer, a first contact on the contact-sensitive display; storing, by the computer, a coordinate associated with the first contact; detecting, by the computer, a second contact on the contact-sensitive display a predetermined amount of time after the first contact is detected; storing, by the computer, a coordinate associated with the second contact; detecting, by the computer, a third contact on the contact-sensitive display a predetermined amount of time after the second contact is detected; and storing, by the computer, a coordinate associated with the third contact.

Another example system for displaying free-form drawing on a contact-sensitive display includes a contact-sensitive display and a processing system. The example system also includes a computer-readable memory in communication with the processing system encoded with instructions for commanding the processing system to execute steps. In executing the steps, a contact-sensitive display is used to sample, by the processing system, coordinates of three consecutive points of a continuous contact operation. A first midpoint that is midway between a first point and a second point of the three consecutive points is identified by the processing system. A second midpoint that is midway between the second point and a third point of the three consecutive points is identified by the processing system. A curve from the first midpoint to the second midpoint is determined by the processing system. The curve is drawn from the first midpoint to the second midpoint on the contact-sensitive display by the processing system.

In the system, the processing system may execute steps including identifying a fourth point of the continuous contact operation; identifying a third midpoint that is midway between the third point and the fourth point of the three consecutive points; determining a second curve from the second midpoint to the third midpoint; and drawing the second curve from the second midpoint to the third midpoint on the contact-sensitive display. In the system, the processing system may execute steps including identifying a fifth point of the continuous contact operation; determining a third curve from the third midpoint to the fifth point; and drawing the third curve from the third midpoint to the fifth point on the contact-sensitive display. In the system, the curve may be a Bezier curve. In the system, the curve may be a quadratic Bezier curve. In the system, the curve may be a second degree curve.

In the system, the processing system may execute steps including drawing a line from the first point to the first midpoint. In the system, drawing the curve may comprise refreshing the contact-sensitive display in a first area, where the first area surrounds the first midpoint and the second midpoint, and where the first area is less than an entire area of the contact-sensitive display. The first area may be a minimized area that includes an entirety of the curve. In the system, the sampling of the coordinates of three consecutive points may include detecting, by the processing system, a first contact on the contact-sensitive display; storing, by the processing system, a coordinate associated with the first contact; detecting, by the processing system, a second contact on the contact-sensitive display a predetermined amount of time after the first contact is detected; storing, by the processing system, a coordinate associated with the second contact; detecting, by the processing system, a third contact on the contact-sensitive display a predetermined amount of time after the second contact is detected; and storing, by the processing system, a coordinate associated with the third contact.

In an example computer-implemented method for providing a simulated replay of a user's interactions with a contact-sensitive display, data associated with a plurality of user interactions with a contact-sensitive display is captured by the computer. The captured data is stored on a non-transitory computer-readable storage medium by the computer. The stored data is retrieved from the non-transitory computer-readable storage medium by the computer. Visual data is generated based on the retrieved data by the computer, where the visual data comprises a simulated replay of the plurality of user interactions. A speed at which interactions occur in the simulated replay is based on a speed at which the plurality of user interactions occurred during the capturing.

In the computer-implemented method, the plurality of user interactions may comprise a writing or drawing operation performed by a user on the contact-sensitive display, and the simulated replay may recreate each user interaction utilized in creating a final writing or drawing on the contact-sensitive display. In the computer-implemented method, the visual data may be a video that recreates the plurality of user interactions, and a speed at which interactions occur in the video may be equal to the speed at which the plurality of user interactions occurred during the capturing. In the computer-implemented method, the data may include, for each user interaction, (i) a first value indicating a timestamp associated with the user interaction, and (ii) a second value indicating a type of interaction associated with the user interaction. The data may also include, for one or more of the user interactions, a third value indicating a parameter associated with the user interaction. In the computer-implemented method, the type of interaction indicated by the second value may be a start of a contact on the contact-sensitive display, a movement of a contact on the contact-sensitive display, an end of a contact on the contact-sensitive display, or a selection of an option on the contact-sensitive display. The parameter indicated by the third value may be an x-y coordinate pair indicating a position on the contact-sensitive display.

In the computer-implemented method, the generating of the visual data may comprise starting, by the computer, a clock; accessing, by the computer, data associated with a first user interaction of the plurality of user interactions; and when the timestamp associated with the first user interaction matches a time of the clock, (i) generating, by the computer, visual data that recreates the first user interaction, and (ii) accessing, by the computer, data associated with a second user interaction that occurred after the first user interaction. In the computer-implemented method, the speed at which the interactions occur in the simulated replay may be equal to the speed at which the plurality of user interactions occurred during the capturing. The computer-implemented method may include providing, by the computer, one or more controls to control playback of the visual data, the one or more controls enabling the simulated replay to be (i) played back in slow motion, (ii) played back in fast motion, (iii) paused, and (iv) stopped. In the computer-implemented method, the plurality of user interactions may include a selection of an option displayed on a graphical user interface (GUI) of the contact-sensitive display, and the simulated replay may include an image of the GUI and may recreate the user's selection of the option by highlighting an area of the image.

An example system for providing a simulated replay of a user's interactions with a contact-sensitive display includes a first computing system including a contact-sensitive display. The first computing system is configured to capture data associated with a plurality of user interactions with the contact-sensitive display. The system also includes a second computing system that is different from the first computing system. The second computing system is configured to retrieve data stored on a non-transitory computer-readable storage medium, the retrieved data being same as or representative of the data captured by the first computing system. The second computing system is also configured to generate visual data based on the retrieved data, the visual data comprising a simulated replay of the plurality of user interactions. A speed at which interactions occur in the simulated replay is based on a speed at which the plurality of user interactions occurred during the capturing.

In the system, the plurality of user interactions may comprise a writing or drawing operation performed by a user on the contact-sensitive display, and the simulated replay may recreate each user interaction utilized in creating a final writing or drawing on the contact-sensitive display. In the system, the visual data may be a video that recreates the plurality of user interactions, and a speed at which interactions occur in the video may be equal to the speed at which the plurality of user interactions occurred during the capturing. In the system, the data may include, for each user interaction, (i) a first value indicating a timestamp associated with the user interaction, and (ii) a second value indicating a type of interaction associated with the user interaction. The data may includes, for one or more of the user interactions, a third value indicating a parameter associated with the user interaction. The type of interaction indicated by the second value may be a start of a contact on the contact-sensitive display, a movement of a contact on the contact-sensitive display, an end of a contact on the contact-sensitive display, or a selection of an option on the contact-sensitive display. The parameter indicated by the third value may be an x-y coordinate pair indicating a position on the contact-sensitive display.

In the system, in the generating of the visual data, the second computing system may be configured to start a clock; access data associated with a first user interaction of the plurality of user interactions; and when the timestamp associated with the first user interaction matches a time of the clock, (i) generate visual data that recreates the first user interaction, and (ii) access data associated with a second user interaction that occurred after the first user interaction. In the system, the speed at which the interactions occur in the simulated replay may be equal to the speed at which the plurality of user interactions occurred during the capturing. In the system, the second computing system may be configured to provide one or more controls to control playback of the visual data, the one or more controls enabling the simulated replay to be (i) played back in slow motion, (ii) played back in fast motion, (iii) paused, and (iv) stopped. In the system, the plurality of user interactions may include a selection of an option displayed on a graphical user interface (GUI) of the contact-sensitive display, and the simulated replay may include an image of the GUI and may recreate the user's selection of the option by highlighting an area of the image.

### BRIEF DESCRIPTION OF THE DRAWINGS

FIG. 1 is a block diagram depicting an example educational system including a teacher computer and a plurality of student computers.

FIG. 2A depicts an example multi-function education station that is configured to store and charge tablet computers, among other functions.

FIG. 2B depicts another view of the example multi-function education station of FIG. 2A.

FIGS. 3A-3C depict example screenshots of teacher software that is executed on a teacher computer.

FIG. 4 depicts an example screenshot of “Writing Exercise—Quick Builder Screen” software that is used by a teacher to generate a writing exercise that can be completed by a student using a tablet computer.

FIG. 5 is a block diagram depicting a streaming of lessons from a teacher computer to student tablets.

FIG. 6 depicts an example screenshot of a writing exercise that is completed by a student on a student tablet computer.

FIG. 7 is a diagram depicting a free-drawing processing module configured to display free-form drawing on a contact-sensitive display while rejecting certain undesirable drawing contacts.

FIGS. 8A, 8B, 8C, 8D, and 8E depict example operations associated with a method of displaying free-form drawing on a touch-sensitive display.

FIGS. 9A, 9B, 9C, 9D, and 9E depict further example operations associated with a method of displaying free-form drawing on a touch-sensitive display.

FIGS. 10A and 10B depict additional example operations associated with a method of displaying free-form drawing on a touch-sensitive display.

FIG. 11 is a diagram depicting an example method of displaying free-form drawing on a touch-sensitive display.

FIGS. 12A, 12B, 13 and 14 depict example operations associated with a method of smoothing a visualization of free-form drawing on a touch-sensitive display.

FIG. 15 is a flow diagram depicting an example process for displaying free-form drawing on a contact-sensitive display.

FIG. 16 is a flow diagram depicting a process of capturing user interactions with a contact-sensitive device and providing a real-time simulation replay of the user interactions.

FIG. 17 is a diagram depicting a graphical user interface for selecting an interaction capture session for viewing.

FIGS. 18A and 18B are diagrams depicting user interfaces for viewing a simulation of the user interactions.

FIG. 19 is a diagram depicting a graphical user interface that provides correctness indications for different user activities.

### DETAILED DESCRIPTION

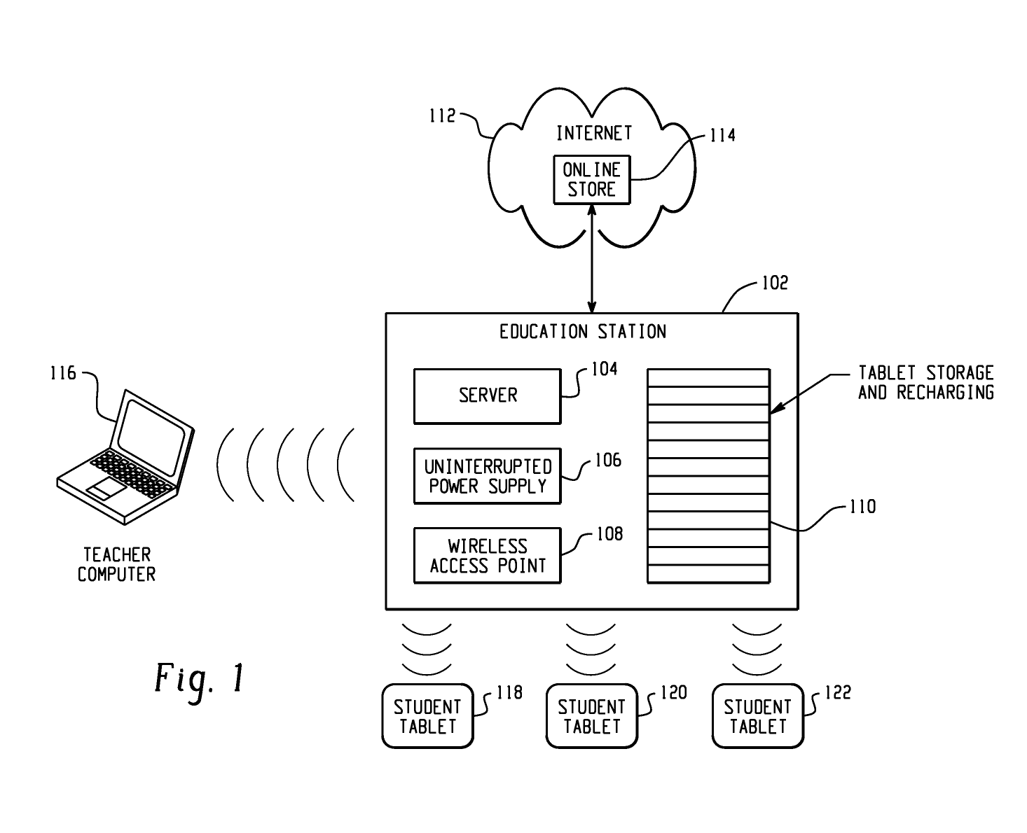

FIG. 1 is a block diagram depicting an example educational system including a teacher computer 116 and a plurality of student tablets 118, 120, 122. The example educational system of FIG. 1 is a computer-based system configured to be used in the instruction, assessment, and management of a classroom of students. The computer-based system described herein differs from conventional educational systems that utilize primarily paper- and pencil-based instruction and assessment. Such paper- and pencil-based systems may include the use of student exercises and tests implemented via paper handouts, for example. To eliminate the need for such paper handouts, the computer-based system described herein allows a teacher to create digital exercises and assessments that are distributed wirelessly to the student tablets 118, 120, 122. Students complete the exercises and assessments using the student tablets 118, 120, 122, and the students' work is transmitted wirelessly from the student tablets 118, 120, 122 to the teacher computer 116 that is operated by the teacher. The teacher can review and assess the students' work using the teacher computer 116. In this manner, the instruction and assessment of the students is performed without a need for conventional paper handouts.

In the example of FIG. 1, the teacher computer 116 is a laptop computer configured to send and receive data wirelessly (e.g., using a WiFi network, etc.). In other examples, the teacher computer 116 is a desktop computer that is configured to send and receive data via a wireless connection or wirelessly. In other examples, the teacher computer 116 is a tablet computer, smartphone, PDA, or another mobile communications device. The teacher computer 116 executes software (referred to herein as “teacher software”) that enables the teacher to create exercises, lessons, and assessments. The teacher software may provide other functionality, such as functionality that enables the teacher to record grades, view and update information for students, create groups of students, and download exercises and lessons from an online store 114.

In an example, using the teacher software that is executed on the teacher computer 116, the teacher creates student exercises. The student exercises may include, for example, writing exercises (e.g., exercises designed to develop students' handwriting skills), Internet exercises (e.g., exercises that require students to research a topic on the Internet 112), math exercises, fill-in-the-blanks exercises, and multiple choice exercises, among others. Using the teacher software that is executed on the teacher computer 116, the teacher creates lessons based on the exercises. In an example, a lesson comprises a sequence of exercises. A lesson may contain, for example, a writing exercise followed by a math exercise. Using the teacher software, the teacher may set the sequence of the exercises in the lesson and specify an amount of time that students may spend on each of the exercises.

After creating a lesson, the teacher may use the teacher software executed on the teacher computer 116 to cause the lesson to be “streamed” (e.g., transmitted) wirelessly to the student tablets 118, 120, 122. During the streaming, the student tablets 118, 120, 122 receive the lesson wirelessly, and students work on the lesson using the tablets 118, 120, 122. To work on the lesson, students interact with a contact-sensitive display (e.g., a touch-sensitive display) of the student tablets 118, 120, 122. In an example, the students maneuver their fingers or a stylus on the contact-sensitive display, thus enabling the students to “write” on the contact-sensitive displays and thereby work on the lesson. To process such inputs via the contact-sensitive display, the student tablets 118, 120, 122 execute software (referred to herein as “student software”). The student software enables the lesson to be rendered on the student tablets 118, 120, 122, thus enabling the students to view content of the lesson and provide input for completing the lesson.

During the streaming of the lesson, the teacher can monitor students' progress via the teacher computer 116. In an example, as students work on the lesson via the student tablets 118, 120, 122, data representative of the students' work is transmitted wirelessly to the teacher computer 116. The receipt of this data at the teacher computer 116 enables the teacher to view students' status (e.g., student has finished lesson, student is working on lesson, etc.) and view students' work (e.g., students' answers to questions). In other examples, additional data is available at the teacher computer 116 for monitoring the students' progress. Additionally, the teacher can interact with the student tablets 118, 120, 122 by taking control of the student tablets using the teacher computer 116. Using the teacher computer 116, for example, the teacher can take control of one or more of the student tablets 118, 120, 122 and use this control to “write” on a tablet's display in order to teach a student how to write a word or solve a math problem.

When streaming is stopped (e.g., as determined by a teacher input at the teacher computer 116 or based on a predetermined time associated with the lesson), the students' work is saved, and students can no longer interact with the lesson via the tablets 118, 120, 122. The teacher can access the saved work via the teacher software that is executed on the teacher computer 116. The saving and accessing of the students' work is described in further detail below. Using the teacher software, the teacher can grade students' work and provide feedback to students, among other functions. It is noted that in an example, all communications between the teacher computer 116 and the student tablets 118, 120, 122 occur via wireless communications.

To support the wireless communications and other functions of the computer-based educational system described herein, the system includes an education station 102, in an embodiment. The education station 102 is configured to perform multiple functions. In an example, the education station 102 provides an area 110 for tablet storage and recharging. Thus, when not being used to complete an exercise, lesson, or assessment, the student tablets 118, 120, 122 are stored in the area 110, enabling the tablets' batteries to be recharged (e.g., via AC power). The storage of the tablets 118, 120, 122 in the area 110 also protects the tablets from physical damage (e.g., protecting the tablets from dropped objects or spilled drinks).

In an example, the education station 102 includes a server 104. The server 104 is configured to store data that is accessed by the teacher computer 116 and the student tablets 118, 120, 122. For example, after the teacher creates a lesson via the teacher computer 116, the lesson is stored to the server 104, in an example. When the lesson is made available to the student tablets 118, 120, 122, the student tablets access the lesson via the server 104, in an example. Further, when streaming of the lesson is complete, the students' work is saved on the server 104. The teacher then accesses the students' work on the server 104 using the teacher computer 116. In general, the server 104 is used to store both teacher data (e.g., information on classes, exercises, lessons, etc.) and student data (e.g., students' work, scores, etc.).

The education station 102 further includes an uninterruptible power supply (UPS) 106, in an example. The UPS 106 is used to provide emergency power in situations where a main power source (e.g., AC power provided by a power utility) fails. The UPS 106 is further used to protect hardware of the computer-based educational system from an unexpected power disruption. In an example, an unexpected power disruption may be harmful to the server 104 or the tablets stored in the recharging area 110 or may cause a loss of data in either of these components. To prevent such harm or loss of data, the UPS 106 provides protection from input power interruptions by supplying energy from a secondary power supply (e.g., a battery, supercapacitor, etc.).

To support wireless communications in the computer-based educational system described herein, the education station 102 includes a wireless access point 108, in an example. The wireless access point 108 is a device that enables the teacher computer 116, the student tablets 118, 120, 122, and any other wireless devices included in the educational system (e.g., a teacher's smartphone or PDA) to communicate via a wireless local area network (LAN) using WiFi or another wireless standard. Using the wireless LAN, the teacher computer 116 and the student tablets 118, 120, 122 can exchange data (e.g., exercises, lessons, student work, grades, feedback, etc.) with one another. The wireless access point 108 enables the teacher computer 116 to stream exercises and lessons wirelessly to the student tables 118, 120, 122. The wireless access point 108 also enables the students' work on the student tablets 118, 120, 122 to be transmitted wirelessly to the teacher computer 116. Although example systems described herein utilize wireless networks and wireless exchange of data, in other examples, a wired network is utilized to exchange data between components of a system. Thus, for example, in the context of FIG. 1, the teacher computer 116 and the student tablets 118, 120, 122 may be connected via wires to a router, switch, or other networking device that enables these components to exchange data via a wired network. Various other types of wired networks may be utilized in other examples.

The wireless access point 108 also provides the teacher computer 116 and the student tablets 118, 120, 122 with access to the Internet 112. Students access the Internet 112 via the student tablets 118, 120, 122 in order to complete Internet exercises assigned by the teacher (e.g., exercises that require students to research a topic on the Internet 112, etc.) or for other reasons. The teacher accesses the Internet 112 via the teacher computer 116 in order to utilize the online store 114, in an embodiment. In an example, rather than manually creating all exercises and lessons by himself or herself, the teacher may download lessons to the teacher computer 116 from the online store 114. The online store 114 includes (i) free exercises and lessons, and (ii) exercises and lessons that can be purchased at a cost to the teacher or school, in an example. Further, using the teacher software executed on the teacher computer 116, the teacher can upload and publish his or her exercises and lessons to the online store 114. The online store 114 may thus provide a means for educators to share exercises and lessons with one another.

It is noted that the components of the education station 102 and the functionality of the education station 102 described above are examples only. In other examples, the education station 102 includes other components (e.g., computing devices, displays, input/output devices, etc.) and is configured to perform other functions (e.g., to function as a projector, etc.).

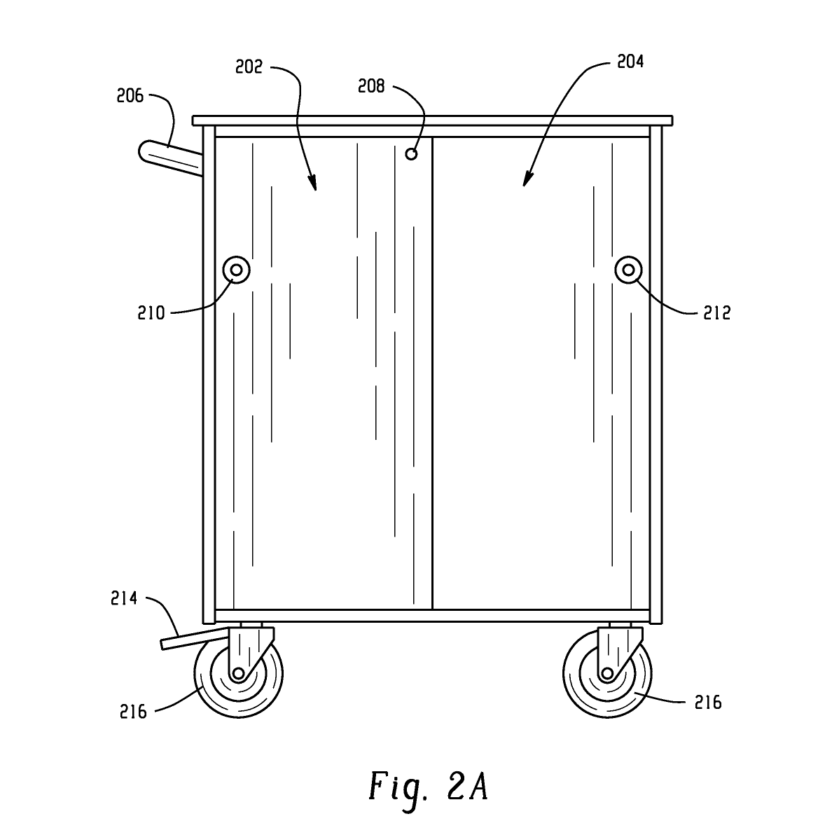

FIGS. 2A and 2B depict an example multi-function education station that is configured to store and charge batteries of tablet computers, among other functions. As described above with reference to FIG. 1, a computer-based educational system includes an education station (e.g., the education station 102 in the example of FIG. 1) that includes an area for storing and recharging multiple student tablets, a server, an uninterruptible power supply, and a WiFi wireless access point, in an example. FIGS. 2A and 2B depict example features of such an education station.

In FIG. 2A, the depicted education station includes sliding doors 202, 204. The sliding doors are opened when components (e.g., the server, wireless access point, etc.) of the education station are to be accessed but are otherwise kept closed to protect the components from inadvertent damage, in an embodiment. Handles 210, 212 are used in opening and closing the sliding doors 202, 204, and a lock 208 is used to prevent the sliding doors from being opened. The education station of FIG. 2A also includes wheels (e.g., casters) 216 that enable the education station to be moved about a classroom or from one classroom to another. In moving the education station, a maneuvering handle 206 may be used. Wheel-locking brakes 214 are engaged when the education station is to be kept stationary.

FIG. 2B depicts another view of the example education station of FIG. 2A. In FIG. 2B, the sliding door 204 has been opened. The opening of the sliding door 204 shows that an interior of the education station includes (i) storage space 220 (e.g., for a teacher computer, etc.), and (ii) an area 222 for storing student tablets and recharging the batteries of the student tablets. A number of student tablets used in the computer-based educational system described herein varies in different examples. In examples of the system, six (6), fifteen (15), or thirty (30) student tablets may be used, for example. Thus, the area 222 for storing student tablets and recharging the batteries of the student tablets in the education station may vary based on the number of student tablets used. In an example, the student tablets are custom-built tablets designed specifically for use with the computer-based educational system described herein. In other examples, the student tablets are commercial, off-the-shelf tablet computers (e.g., iPads, tablets utilizing the Android operating system, etc.) onto which the student software described herein is installed.

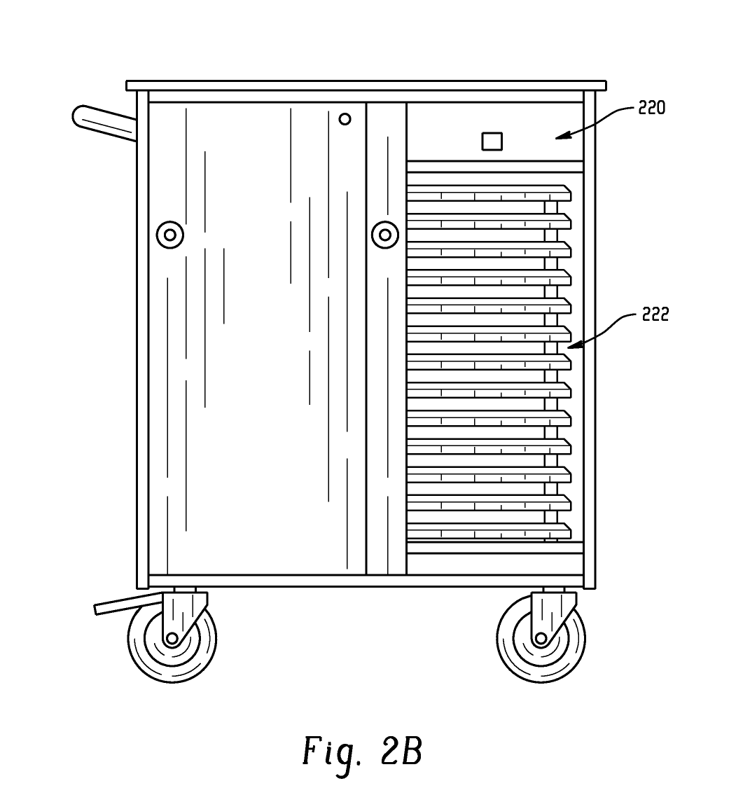

FIGS. 3A-3C depict example screenshots of teacher software that is executed on a teacher computer. As described above, in the computer-based educational system described herein, a teacher computer (e.g., teacher computer 116 depicted in FIG. 1) executes teacher software that enables a teacher to create exercises, lessons, and assessments. In an example, the teacher software is configured to provide other functionality, such as functionality that enables the teacher to record grades, view and update information for students, create groups of students, and download exercises and lessons via an online store.

Using a graphical user interface (GUI) of the teacher software, a teacher is able to access the three primary sections of the teacher software, i.e., a “My Classes” section, an “Exercises” section, and a “Lessons” section. For example, as displayed in FIGS. 3A-3C, a first button 302 displayed on the GUI is selected (e.g., clicked, pressed, etc.) by the teacher to access the “My Classes” section of the software, a second button 304 is selected to access the “Exercises” section, and a third button 306 is selected to access the “Lessons” section. The three sections of the software are discussed in turn below with reference to FIGS. 3A-3C, respectively.

FIG. 3A depicts aspects of the “My Classes” section of the teacher software. The example screenshot depicted in FIG. 3A is the result of the teacher selecting the first button 302 (e.g., labeled “My Classes”), in an embodiment. As illustrated in FIG. 3A, the “My Classes” section enables the teacher to view information about students that are associated with the teacher. The screenshot shows that the students are divided into groups 308, 310, 312. For each of the groups 308, 310, 312, the software provides students' names and photographs of the students. In an example, each of the names and photographs can be selected (e.g., clicked) to access additional information about a student. For example, the teacher may click on a student's name or photograph to access the record of the student (e.g., including biographical information about the student, work previously generated by the student, grades, teachers' notes about the student, etc). By accessing the student's record, the teacher is able to view the record and update the record (e.g., input new grades for the student, etc.). The teacher may also access and update a student's record by searching for the student's name using text input box 316, in an embodiment.

The “My Classes” section of the teacher software also enables the teacher to create a class using the “Create Class” button 314. Classes are created by manually entering information for each student of a class (e.g., surname, first name, gender, date of birth, etc.) or by importing a file (e.g., a Microsoft Excel file, an Apache OpenOffice file, etc.) that contains class information. After a class has been created, the teacher may use the “My Classes” section of the teacher software to create student groups within the class and modify the distribution of students between the different groups. In the example of FIG. 3A, the students of Student Groups 308, 310, 312 comprise students of a single class that are grouped according to some criteria (e.g., interests, achievement level, etc.).

FIG. 3B depicts aspects of the “Exercises” section of the teacher software. The example screenshot depicted in FIG. 3B is the result of the teacher selecting the second button 304 (e.g., labeled “Exercises”), in an embodiment. As illustrated in FIG. 3B, the “Exercises” section enables the teacher to view previously-created exercises 334-352. In an example, the previously-created exercises 334-352 are sorted by date (e.g., most recent exercises first) or by name. Each of the exercises is represented by an appropriate icon, and each of the icons has associated text (e.g., a filename or excise name) that is descriptive of the exercise, in an embodiment. In an example, the icons representing the exercises 334-352 can be selected (e.g., clicked) to access or edit an exercise or to view other information about an exercise.

The “Exercises” section of the teacher software also enables the teacher to create an exercise using the “Create Exercise” button 315. In an example, the teacher selects the “Create Exercise” button 315, and this causes exercise creation modules 317, 318, 320, 322, 324, 326, 328, 330, 332 to appear in the GUI. The teacher can then select one of the exercise creation modules to create an exercise. The “Document Import” exercise creation module 317 allows the teacher to import documents in various formats (e.g., PDF, Microsoft Word, Microsoft PowerPoint, Apache OpenOffice, etc.) for use as exercises. After importing the document, the teacher software enables the teacher to edit the document for use as an exercise (e.g., adding text to the document, “writing” on the document, making portions of the document not viewable, etc.).

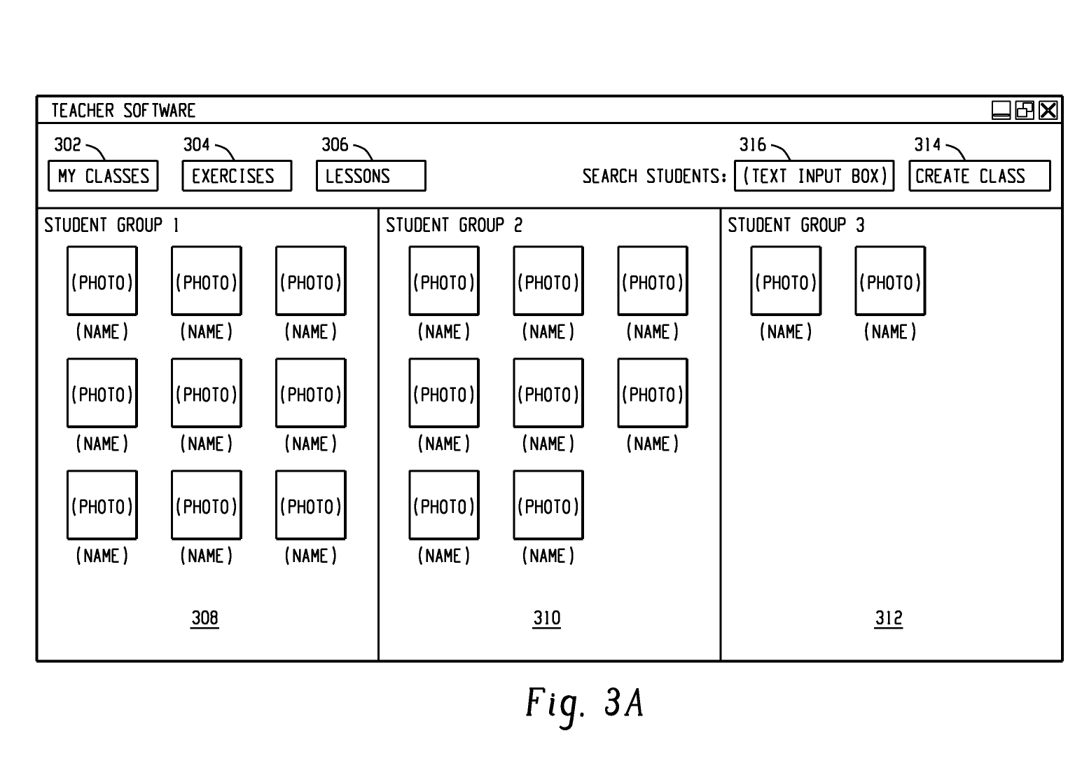

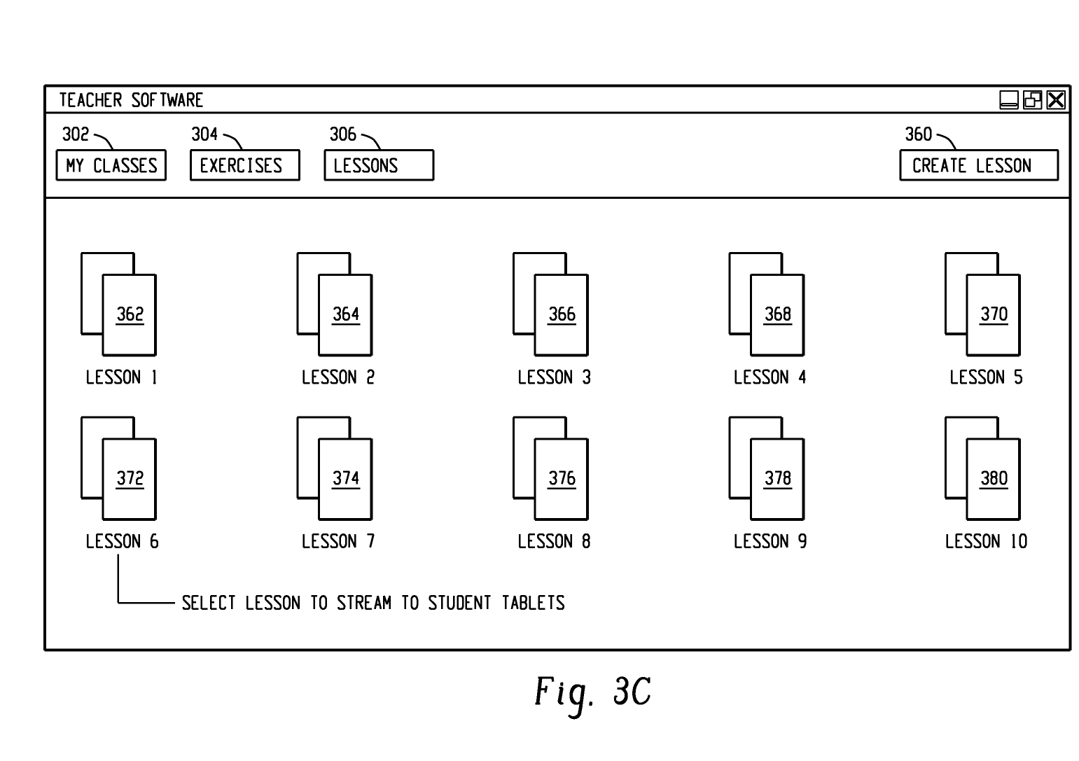

The “Writing Exercise” creation module 318 allows the teacher to create an exercise aimed at the production of a written text. A writing exercise is used, for example, to instruct students who are learning to write (e.g., cursive handwriting), to enable students to provide constructed responses to essay questions (e.g., sentences, short phrases, paragraphs, etc.), and to instruct students in learning conjugation, vocabulary, or other language-related endeavors. Such writing exercises are completed by the students using the student tablets (e.g., the student tablets 118, 120, 122, as illustrated in FIG. 1), which allow the students to “write” on a contact-sensitive display of the tablet by maneuvering their fingers or a stylus on the display. The creation of writing exercises using the teacher software and the completion of such exercises using a student tablet are described in further detail below with reference to FIGS. 4 and 6, respectively.

The “Labels Exercise” creation module 320 allows the teacher to create an interactive exercise based on the association of an image with letters, words, short sentences, or numbers. In creating an example labels exercise, the teacher selects an image of a map of the United States of America, where four of the states have been highlighted. The teacher generates four “labels,” which consist of names of the states that are highlighted in the map. The teacher inputs a prompt (e.g., “Match the four highlighted states with their names”). In performing the exercise, the student is able to drag the labels onto the map, thus associating the state names with the highlighted states. It is noted that the labels exercise described herein is exemplary only, and that other types of labels exercises are created in other examples.

The “Internet Exercise” creation module 322 allows the teacher to create an “Internet surfing exercise.” Such an exercise requires students to research a topic or answer a question using the Internet, in an example. In creating an Internet exercise, the teacher chooses the students' access level to the Internet. Different options for student access level to the Internet include (i) full access (e.g., no restrictions, able to access any site on the Internet or any site not blocked by age-appropriate filtering software), (ii) modified access (e.g., free surfing within a given site), and (iii) restricted access (e.g., student is permitted 0, 1, 2, or n clicks on a chosen website or page).

The “Math Operations Exercise” creation module 324 allows the teacher to create a “mathematical operations” exercise. Specifically, this creation module 324 allows the teacher to create interactive mental or written calculation exercises, where students write answers to by hand (e.g., using a finger or stylus on a contact-sensitive display of a student tablet computer, etc.) or by typing (e.g., using an on-screen keyboard displayed on the student tablet computer, using a hardware keyboard that is part of the student tablet, etc.). The “Math Operations Exercise” creation module 324 enables the teacher to generate a calculation exercise (i) in an automatic manner (e.g., the teacher software automatically generates calculation exercises based on defined criteria, such as type of operation, number of operators, etc.), or (ii) manually (e.g., where the teacher manually chooses all numbers and mathematical operators, etc.). The calculation exercises are based on addition operations, multiplication operations, subtraction operations, and division operations, in an example. In an example math operations exercise, the exercise presents (i) a text prompt “6 x 6=” and (ii) a text input box that enables a student to write or type his or her answer to the question posed by the prompt. In other examples, more complex math problems are presented (e.g., long division, long multiplication problems, etc.), and the student is required to show his or her work, which can be reviewed by the teacher.

The “Math Tables Exercise” creation module 326 allows the teacher to create a “math tables” exercise. Specifically, this creation module 326 enables the teacher to create interactive calculation exercises based on addition or multiplication tables, where the students write answers to the exercises by writing on the display screen or by typing. The “Math Tables Exercise” creation module 326 enables the teacher to generate a calculation (i) in an automatic manner (e.g., the teacher software automatically generates calculation exercises based on a teacher's selection of an operation type and a math table), or (ii) by manually choosing the proposed calculations. The math tables exercises are based on addition operations and multiplication operations, in an example.

The “Fill-In-The-Blanks Exercise” creation module 328 allows the teacher to create a “fill-in-the-blanks” exercise. Specifically, this creation module 328 enables the teacher to create interactive exercises based on the association of letters, words, sentences, or numbers with a text. This module is also used, in an example, to allow students to work on punctuation. In an example, the creation module 328 enables the teacher to input one or more sentences. After inputting the one or more sentences, the teacher uses the creation module 328 to remove portions of the one or more sentences. The removed portions are words, phrases, or punctuation, in an example. In the exercise presented to the student, the student is given the one or more sentences with “blanks” used in the portions removed by the teacher. A prompt of a fill-in-the-blanks exercise requests that the student fill in the blanks with appropriate words, phrases, or punctuation.

The “Whiteboard Exercise” creation module 330 enables the teacher to create a “whiteboard” exercise. Specifically, this creation module 330 enables the teacher to create activities based on the free handling of multimedia objects on a pre-defined background. In an example, the creation module 330 enables the teacher to select a background image for the exercise. After selecting the background image, the teacher selects objects (e.g., text objects, image objects, video objects, audio objects, etc.) to be used in the exercise. The teacher is able to manipulate the objects (e.g., resizing, etc.) and choose where the objects are placed atop the background image. Using the objects, the teacher is able to create an exercise with the form of the exercise being freely chosen by the teacher. In an example, the teacher selects two image objects (e.g., images of a fox and a spider) and two text objects (e.g., text that says “fox” and “spider”). In the example, the teacher creates a prompt that says “Put the name of the animal below the image of the animal.”

The “Multiple Choice Exercise” creation module 332 enables the teacher to create a multiple-choice exercise. Using this creation module 332, the teacher is able to input a prompt (e.g., a question to be answered) and the choices from which the student can select to answer the prompt.

FIG. 3C depicts aspects of the “Lessons” section of the teacher software. The example screenshot depicted in FIG. 3C is the result of the teacher selecting the third button 306 (e.g., labeled “Lessons”), in an embodiment. In an example, a lesson comprises a particular sequence of exercises. As illustrated in FIG. 3C, the “Lessons” section enables the teacher to view previously-created lessons 362-380. In an example, the previously-created lessons 362-380 are sorted by date (e.g., most recent exercises first) or by name. Each of the lessons is represented by an appropriate icon, and each of the icons has associated text (e.g., a name of the lesson) that is descriptive of the lesson, in an embodiment.

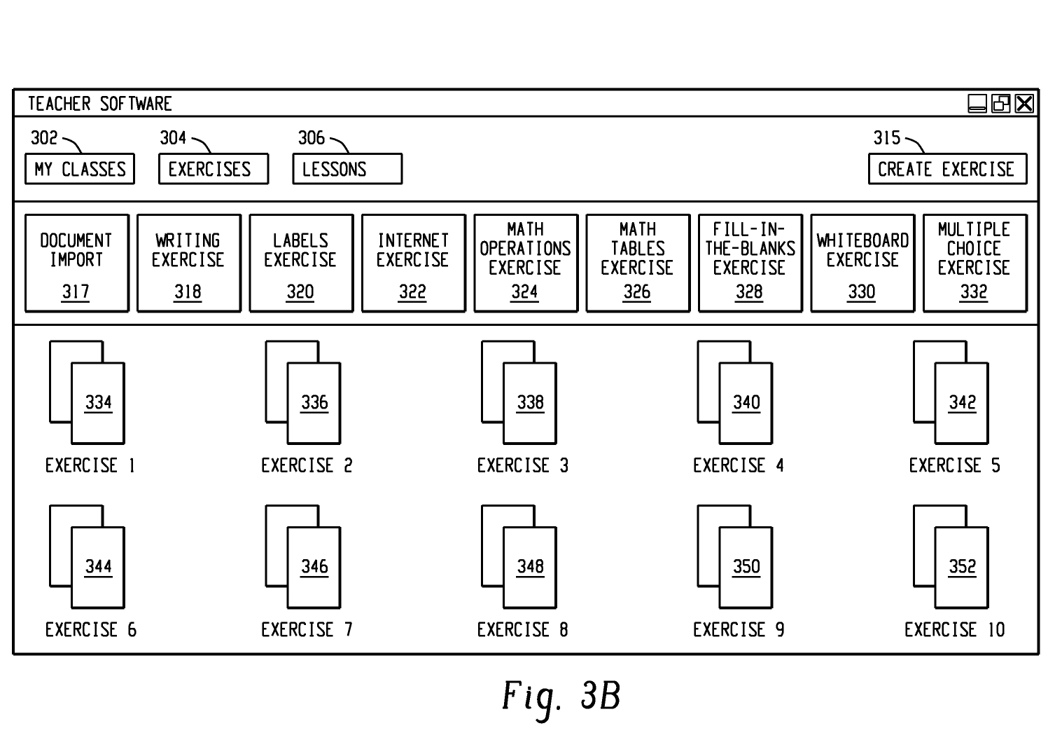

In an example, the icons representing the lessons 362-380 can be selected (e.g., clicked) to access or edit a lesson or to view information about a lesson. Further, in an example, selecting a lesson enables the teacher to “stream” the lesson. The lesson is streamed, for example, to student tablets, to a video projector, or to an interactive whiteboard, for example. When the lesson is being streamed to student tablets, the teacher uses a teacher computer (e.g., the teacher computer 116 of FIG. 1) to monitor the activity of students and view the work of the students. The streaming of lessons to student tablets is described in further detail below with reference to FIG. 5.

The “Lessons” section of the teacher software also enables the teacher to create a lesson using the “Create Lesson” button 360. In an example, when the button 360 is selected, the teacher is able to select exercises and other documents that are to be included in a lesson. Selection of the button 360 also allows the teacher to associate student groups with a lesson. As described above with reference to FIG. 3A, the “My Classes” section of the teacher software allows the teacher to create groups of students within a class. After a student group has been created, the created student group can be associated with a lesson that is created via the “Lessons” section of the teacher software. When the teacher is satisfied with the lesson, the teacher can save the lesson, and the saved lesson will then be available for streaming to student tablets via the “Lessons” section of the teacher software. In an example, the saved lesson is included in a list of lessons presented in the “Lessons” section, and the teacher can then select the lesson to stream it to student tablets.

FIG. 4 depicts an example screenshot 402 of “Writing Exercise—Quick Builder Screen” software that is used by a teacher to generate a writing exercise that is completed by a student using a tablet computer. As described above with reference to FIG. 3B, the teacher software described herein includes a “Writing Exercise” creation module that enables the teacher to create a writing exercise. Such a writing exercise is completed by students using student tablets, which allow students to “write” on a contact-sensitive display of a tablet by maneuvering their fingers or a stylus on the display. The writing exercise creation module described herein includes the “Writing Exercise—Quick Builder Screen” software illustrated in FIG. 4, in an example.

As illustrated in FIG. 4, the writing exercise creation module includes a configuration area (e.g., depicted as being on a left-hand side of the example screenshot 402) that enables the teacher to choose exercise parameters 404. For example, the teacher is able to choose a writing grid 408 used in the writing exercise, in an embodiment. Different writing grid options available to the teacher are distinguished based on a density of lines included in each of the writing grids, in an example. The teacher is also able to choose a “writing hint” parameter 410. For example, in an exercise, a student is asked to write a word or letter in proper cursive handwriting. If a first writing hint option 410 is chosen, the student is provided no hint (e.g., the student is asked to write the word or letter and is provided with no additional information). If a second writing hint option 410 is chosen, the student is provided a first type of hint, where the first type of hint displays a proper starting point for writing the word or letter. If a third writing hint option 410 is chosen, the student is provided a second type of hint, where the second type of hint displays a “watermark” or “shadow” of the text that the student is asked to write. With the third writing hint option 410, the student is able to trace over the watermark or shadow to generate the requested word. In the configuration area of the writing exercise creation module, the teacher can also choose (i) a font 412 for instructions presented to the student, and (ii) a maximum duration for the exercise 414.

The writing exercise creation module also includes a workspace area (e.g., depicted as being on a right-hand side of the example screenshot 402) that enables the teacher to provide instructions for the exercise in writing or sound (e.g., recorded using the laptop or by importing a sound file in wave or MP3). In the example of FIG. 4, the teacher uses a text input box 406, to enter text instructions for the exercise (e.g., “In proper cursive handwriting, write ‘the car’ and ‘the sailing leaf.’”). Additionally, the teacher is able to enter text in writing grids 416, 418 that are part of the writing exercise. The text entered into a writing grid may be typed by the teacher or handwritten by the teacher (e.g., using a mouse or other input device, or by the teacher interacting with a contact-sensitive display using a stylus or his or her finger). The text provided by the teacher is the text that the student is asked to write, in an example. In other examples, no text is provided in the writing grids 416, 418 as part of the exercise.

A “Cancel” button is used to exit the writing exercise creation module, and a “Save” button is used to save the writing exercise. After saving the exercise, the exercise is available for inclusion in a lesson that is streamed to student tablets. Additionally, after saving the exercise, the exercise is available in the “Exercises” section of the teacher software, thus allowing the teacher to select and edit the exercise at a later point in time, among other options.

FIG. 5 is a block diagram depicting a streaming of lessons 524, 526 from a teacher computer 516 to student tablets 518, 522. As described above with reference to FIG. 3C, after creating a lesson, a teacher can use teacher software executed on a teacher computer to stream the lesson to student tablets. When the lesson is being streamed to student tablets, the teacher uses the teacher computer to monitor the activity of students and view of the work of the students. Aspects of this streaming procedure are illustrated in FIG. 5.

In FIG. 5, students use the student tablets 518, 522, and the teacher uses the teacher computer 516. The student tablets 518, 522 execute student software (e.g., student software that enables the student tablets 518, 522 to render exercises and lessons and receive input from a student to complete the exercises and lessons, etc.), and the teacher computer 516 executes teacher software (e.g., teacher software that enables the teacher computer 516 to create exercises, lessons, and assessments, etc.), in an embodiment. Student tablets and teacher computers are described in further detail above with reference to FIG. 1. After creating the lessons 524, 526, the teacher uses the teacher software executed on the teacher computer 516 to cause the lessons 524, 526 to be “streamed” (e.g., transmitted) wirelessly to the student tablets 518, 522, respectively. A single WiFi connection may be used by all of the student tablets 518, 522 to receive the respective lessons 524, 526. Thus, although FIG. 5 depicts the lessons 524, 526 being transmitted to the respective student tablets 518, 522 via separate “streams,” it is noted that a single WiFi connection may be utilized by all of the student tablets 518, 522.

During the streaming, the student tablets 518, 522 receive the respective lessons 524, 526 wirelessly, and students work on the lessons 524, 526, using the tablets. In an example, the teacher uses the teacher software to select a particular group of student tablets to which a lesson should be streamed. In this manner, the lessons streamed to tablets are individualized and targeted to the skills and abilities of the students that use the particular group of student tablets. Thus, in an example, the tablets 518, 522 may each be associated with a particular group of students, such that the lesson 524 is targeted to a first group of students utilizing the tablet 518, and the lesson 526 is targeted to a second group of students utilizing the tablet 522. It should be appreciated that although tablets 518, 522 are depicted in FIG. 5 as being single tablets, each of the depicted tablets 518, 522 may represent one or more tablets that are utilized by a respective group of students. Thus, the first group of students may utilize one or more tablets 518 that receive the lesson 524, and the second group of students may utilize one or more tablets 522 that receive the lesson 526.

During the streaming of the lessons 524, 526, the teacher can monitor students' progress via the teacher computer 516. In an example, as students work on the lessons 524, 526 via the student tablets 518, 522, data representative of the students' work is transmitted from the tablets 518, 522 to the teacher computer 516 using wireless communications. The receipt of this data at the teacher computer 516 enables the teacher to view students' statuses, in an example. Status indicators 530 received at the teacher computer 516 indicate, in an example, (i) that a student has finished the lesson (or a portion of a lesson), (ii) that the student is actively working on the lesson (e.g., the student has interacted with the student tablet in the past n seconds), (iii) that the student has been inactive for a short period of time (e.g., 30 seconds), and (iv) that the student has been inactive for a longer period of time (e.g., 2 minutes).

The data representative of the students' work that is transmitted wirelessly from the student tablets 518, 522 to the teacher computer 516 may also be used to view the students' work 528 on the tablets 518, 522. Such work 528 may include any student input received at the student tablets 518, 522 (e.g., students' answers to questions, etc.). In another example, data received at the teacher computer 516 enables the teacher to view a real-time “video” of a student's work on a tablet. For example, using this data, the teacher software executed on the teacher computer 516 may create a real-time rendering of the student's work 528, showing every student interaction at the student tablet as it occurs. Students' work 528 may be displayed to the entire class using a video projector or an interactive whiteboard.

When streaming is stopped (e.g., as determined by a teacher input at the teacher computer 516 or based on a predetermined time associated with the lesson), the students' work is saved, and students can no longer interact with the lesson via the tablets 518, 522. The teacher can access the saved work via the teacher software that is executed on the teacher computer 516. Using the teacher software, the teacher can grade students' work and provide feedback to students, among other options. It is noted that in an example, all communications between the teacher computer 516 and the student tablets 518, 522 occur via wireless communications. To support these wireless communications, the system includes an education station 502, in an embodiment. The education station 502 includes a wireless access point 508 that enables wireless communications between the teacher computer 516 and the student tablets 518, 522. An exemplary wireless access point 108 is described in greater detail above with reference to FIG. 1. The education station 502 also includes, in an example, a server 504, UPS 506, and an area 510 for tablet storage and recharging. Such components are described in greater detail above with reference to FIG. 1.

FIG. 6 depicts an example screenshot of a writing exercise that may be completed by a student using a student tablet computer. As described above, in the computer-based educational system described herein, student tablets receive lessons from a teacher computer wirelessly, and using the student tablets, students work on the lessons. To work on the lessons, a student interacts with a contact-sensitive display of a student tablet. In an embodiment. In an example, the student maneuvers his or her fingers or a stylus on the contact-sensitive display, thus enabling the students to “write” on the contact-sensitive display. FIG. 6 shows an example of an exercise that is completed by a student using a student tablet, where the exercise requires the student to write on a contact-sensitive display of the tablet. The exercise is presented on the student tablet using student software executed on student tablet, in an embodiment.

As illustrated in FIG. 6, the student software presents, via a GUI, various options that can be selected by the student, in an embodiment. For example, the student software includes on-screen buttons that can be selected by the student to change a drawing or writing tool. For example, using the buttons 564, a student can control a width of lines that are created on the contact-sensitive display, cause lines to be dashed, cause lines to be straight (rather than curved), etc. The student software also includes an on-screen button 562 that enables the student to erase previous work. In an example, pressing the erase button 562 erases the last marking by the student on the contact-sensitive display. In another example, pressing the erase button 562 erases all markings by the student for a current exercise.

The student software also includes an on-screen button 552 that is a “submit button.” In an example, pressing the submit button enables the student to indicate that he or she has finished the current exercise, such that a subsequent exercise may then be presented in the student software. In the example of FIG. 6, the student software also includes various visual indications: a student name 558 indicates a name of the student using the table computer, a name or number 560 identifies an exercise that is currently being displayed, an amount of time 554 indicates an amount of time remaining for the student to complete the exercise, and a battery status indicator 556 indicates an amount of battery life remaining in the student tablet.

In the example of FIG. 6, the exercise may include a prompt that instructs the student to generate, in proper cursive handwriting, text that is provided in the exercise. For example, as shown in the figure, the exercise provides text, “the car” and “the sailing leaf,” and the student is asked to write this same text in proper cursive handwriting. To generate the handwriting, the student uses his or her finger, a stylus, or another apparatus to interact with the contact-sensitive display of the student tablet. It is noted that the exercise illustrated in FIG. 6 is exemplary only. In other exercises, the student is required to draw a picture on the contact-sensitive display, complete a math problem (e.g., a math problem that requires the student to show his or her work and to input all data using the student's finger or stylus), or perform another suitable task.

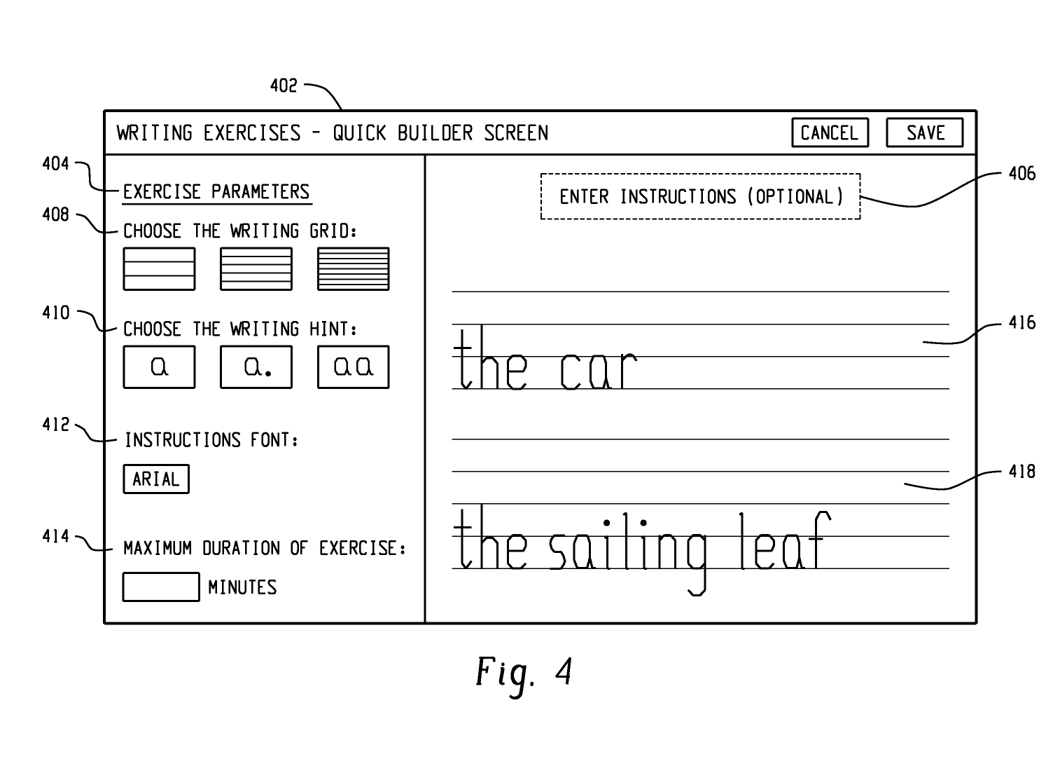

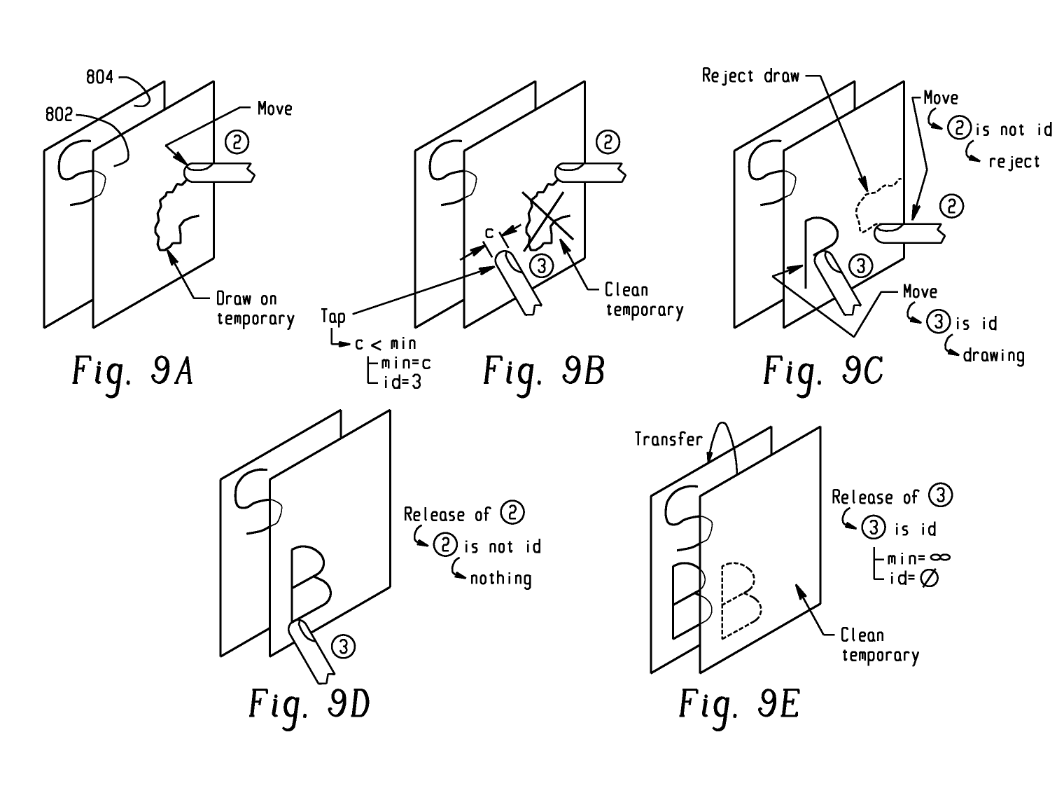

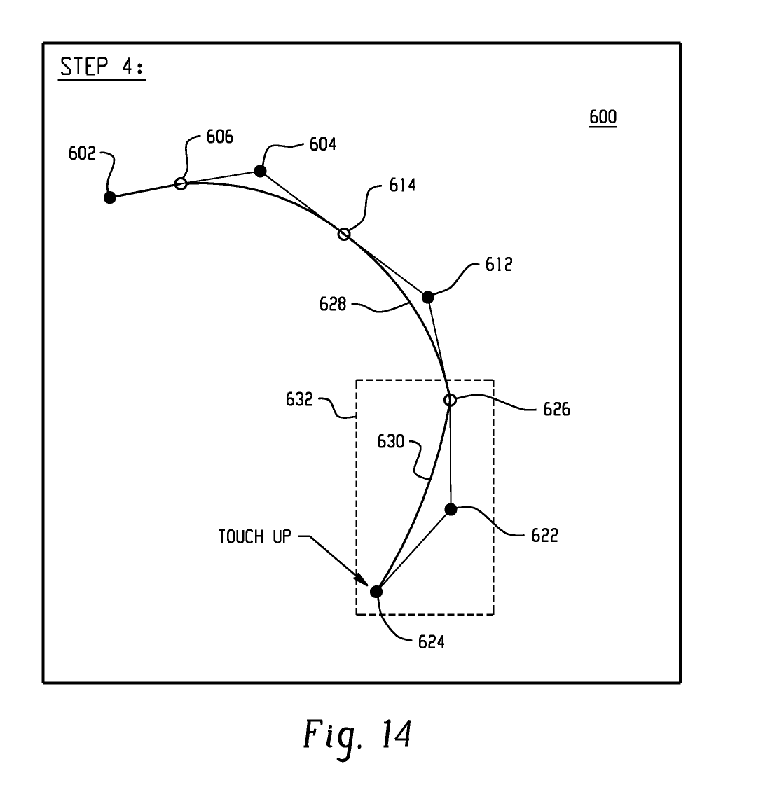

FIGS. 7-19, are directed to systems and methods of processing student input received at a student tablet, where the input is a result of the student interacting with a contact-sensitive display of the student tablet. FIGS. 7-11 are directed to systems and methods for addressing problems caused by the student resting his or her palm or wrist on the contact-sensitive display while writing on the contact-sensitive display. For example, when a student is writing on a contact-sensitive display, such as using a stylus or his or her finger, the student may rest a palm or wrist on the display. Such a palm or wrist is not indicative of the writing that the student is intending to input, and thus, the systems and methods described below are intended to address this issue. FIGS. 12-15 are directed to systems and methods for enabling free-form drawing on a contact-sensitive display to be displayed in a manner that looks “natural.” For example, as described below, certain systems and methods for displaying free-form drawing on a contact-sensitive display utilize sampling procedures, where coordinates associated with current contacts are sampled every n seconds (e.g., every 100 ms). When free-form drawing is being performed quickly, simply connecting-the-dots between sampled coordinates on the contact-sensitive display results in an unnatural-looking drawing, FIGS. 12-15 describe example operations associated with a process for smoothing visualization of free-form drawing on a contact-sensitive display. In a further embodiment of the disclosure described below with reference to FIGS. 16-19, systems and methods are configured to record user interactions with a contact-sensitive device so that a simulation of those interactions can be replayed to that user or a different user at a future time. For example, systems and methods described below can provide a mechanism for a teacher to observe a process by which a student went about doing an exercise or solving a problem to determine a quality of that effort by the student. In one example, a system provides a replay of a user writing on the contact-sensitive device, such as part of a handwriting quality evaluation.

FIG. 7 is a diagram depicting a free-form drawing processing module configured to display free-form drawing on a contact-sensitive display while rejecting certain undesirable drawing contacts. A free-form drawing processing module 702 detects one or more current contacts (e.g., finger contacts, stylus contacts, other contacts) on a contact-sensitive display 704. The free-form drawing processing module 702 is configured to track all or certain of those contacts to determine lines that should be displayed on the display 704. In one embodiment, the drawing processing module 702 uses a plurality of array data structures 706, 708 stored on one or more non-transitory computer readable mediums 710 to track contacts that should be displayed on the screen.

In one embodiment, the main array 706 contains data (e.g., a collection of sampled coordinates of a contiguous contact event (i.e., from initial contact until contact release is detected) for determined desirable contacts. The temporary array 708 contains data associated with current contact events (i.e., contact events where release has not yet been detected) that have not yet been rejected (e.g., deleted, market invalid). Upon contact release, data associated with a contact event that has not been rejected is transferred to the main array 706 and removed (e.g., deleted, marked invalid or inactive) from the temporary array 708. The free-form drawing processing module 702 instructs the contact-sensitive display 704 to utilize data stored in the main array 706 and the temporary array 708 that are associated with determined desirable contacts and unrejected current contacts, respectively, on the contact-sensitive display 704. In this manner, free-form drawing associated with determined desirable contacts having data in the main array 706 is displayed along with free-form drawing associated with current contacts that have not yet been deemed undesirable and rejected. It is noted that steps described above with reference to FIG. 7 are carried out by a computer and/or components of a computer (e.g., a processing system or processor of a computer), in an embodiment.

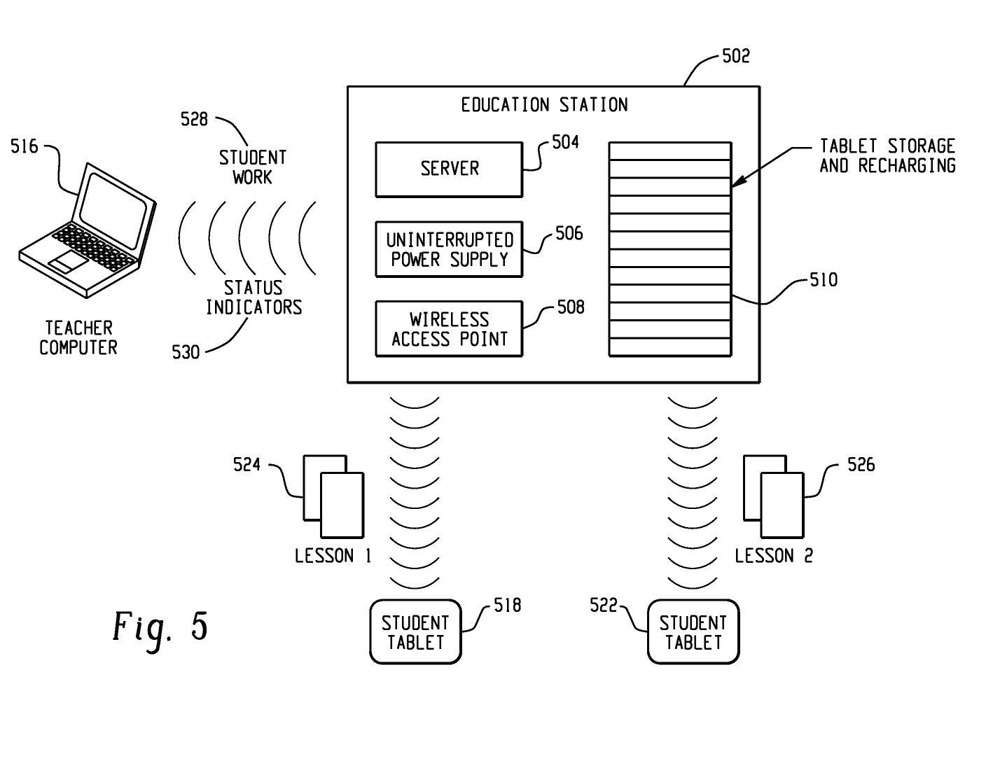

FIG. 8 is a diagram depicting example operations of a first free-form drawing capture operation. FIG. 8A depicts a temporary area 802, corresponding to the first, temporary array 708 of FIG. 7 and a main area 804, corresponding to the second, main array 710. Each area is associated with the contact-sensitive display 704 (e.g., includes cells corresponding to each position of the contact-sensitive display 704). Similar to FIG. 7, the temporary area 802 is configured to store data associated with current contacts that have not been rejected, while the main area 804 is configured to store data associated with determined desirable contacts.

Certain criteria are utilized to determine whether a current contact should be rejected. In the example of FIG. 8, current contacts are rejected initially when their width is greater than a maximum width threshold (e.g., a width is determined by a set of display 704 sensors that detect a threshold change in capacitance based on a contact event). For example, when a user is writing on a contact-sensitive display, such as using a stylus, the user may rest a palm or wrist on the display. Such a palm or wrist is not indicative of desirable drawing that should be displayed. When a new contact is deemed to have a width greater than the maximum width threshold, that new contact is rejected and no longer tracked (e.g., data associated with that no contact is no longer included in temporary area 802 or temporary array 708 and prior tracked data at 802 or 708 for that rejected contact is deleted or marked invalid).

When the width of a new contact is less than a maximum width threshold, that new contact remains eligible for tracking using the temporary area 802. A second rule, in one embodiment, indicates that only a smallest width current contact should be tracked, with other current contacts being rejected. In FIG. 8B, a new contact on the contact-sensitive display is detected. In that example, the new contact is the only current contact and is identified with an identifier, ID=1. Because current contact 1 has a width less than the maximum width threshold, it is not initially rejected. Because it is the current contact having the smallest width, its identifier, 1, is stored in the active current contact identifier, id=1, and its width, a, is stored in variable min=a, indicating that the smallest current contact width is a wide. FIG. 8C depicts a progression of current contact 1, where an “S” shape is continuously drawn on the contact-sensitive display. Data (e.g., sampled current contact coordinates) associated with current contact 1 are stored in the temporary area, indicating that current contact 1 is a current contact that has not yet been rejected. The temporary area data depicted in FIG. 8C is used to visualize the drawing of current contact 1 in real-time or near real-time, giving the appearance of drawing on the contact-sensitive display.

FIG. 8D depicts operations when current contact 1 is released. Because current contact 1 has not yet been rejected, on release, current contact 1 is deemed a desirable contact. The temporary area data associated with current contact 1 is transferred to the main area. Display of the current contact 1 “S” shape is persisted by instructing the contact-sensitive display to use data from both the temporary area 802 and the main area 804 to populate the contact-sensitive display. Thus, the “S” shape remains when the associated current contact 1 data is transferred from the temporary area to the main area. Following transfer in FIG. 8D, the temporary area and associated variables are reset (e.g., sampled coordinates of contact 1 are deleted or marked invalid, the active current contact identifier, id, is set to null, and the width of the active current contact width, min, is set to infinity).

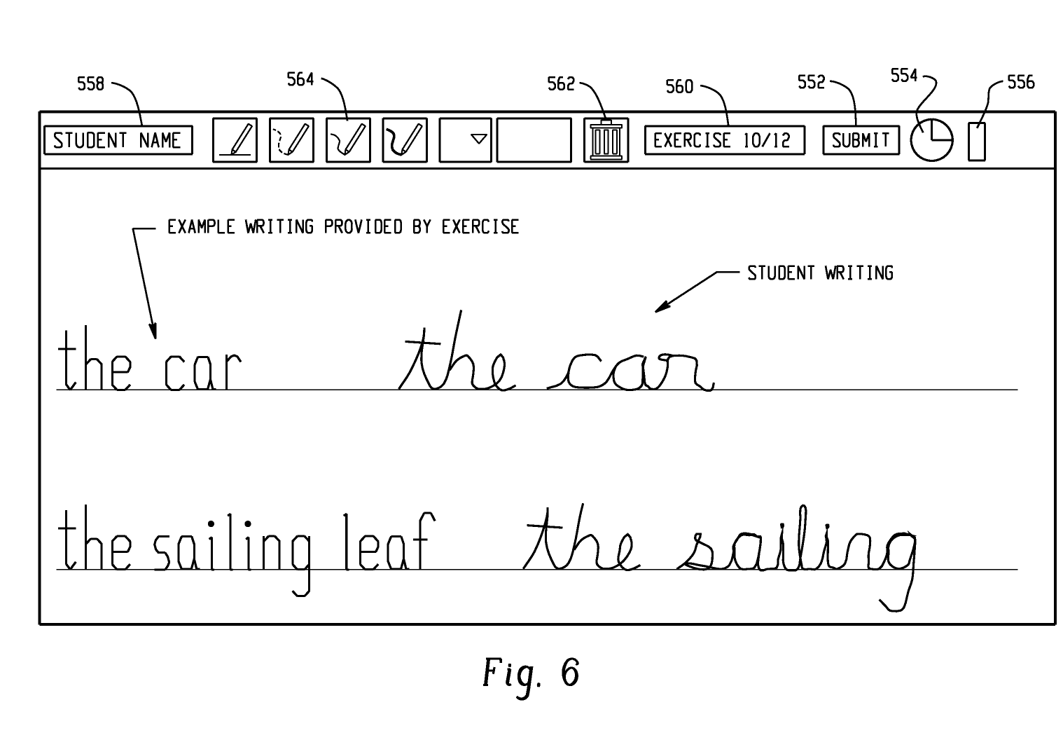

FIG. 8E depicts a detection of a next current contact, which is assigned current contact id=2. Because it is the only current contact and has not been rejected, it is identified as the active current contact by variable id=2. Current contact 2 has a width of b, which is less than the maximum width threshold. Thus, current contact 2 is not initially rejected, its width is stored in the active current contact width variable, min=b, and associated data (e.g., sampled coordinates) are stored in the temporary storage area 802. Example operations continue at FIG. 9, where in FIG. 9A the temporary area 802 is updated with data associated with additional detected movements of current contact 2. As shown in the main contact storage area 804, data associated with earlier contact 1 indicating the “S” shape drawing is continued to be stored and displayed on the contact-sensitive display. In FIG. 9B, a new contact is detected and assigned current contact identifier 3. Current contact 3 has a width, c, that is less than the maximum width threshold. A comparison is made between width c, and the contents of the active current contact width variable, min=b. Because current contact 3's width is smaller, current contact 3 is made the active current contact and current contact 2 is rejected. Current contact 3 is made the active current contact by storing its identifier in the active current contact variable, id=3, and its width in the active current contact width variable, min=c. Current contact 2 is rejected by removing data associated with its prior movement on the contact-sensitive display from the temporary area 802. Because the system is configured to provide the contact-sensitive display using data from both the main area 804 and the temporary area 802, when data associated with rejected current contact 2 is removed from the temporary area 802, lines drawn on the screen associated with current contact 2 will disappear. After rejection, further drawing associated with current contact 2 is not tracked in the temporary area, meaning that no further contact-sensitive display drawing will result from current contact 2. This is illustrated in FIG. 9C, where because current contact 2 does not match the active current contact variable, id=3, any drawing associated with current contact 2 does not result in a change of appearance on the contact-sensitive display.

FIG. 9D depicts further free-form drawing by current contact 3, the active current contact, where data associated with a “B” shape is stored in the temporary area 802. Upon release of current contact 3 (e.g., based on releasing a finger or stylus from the contact-sensitive display), the temporary area data associated with current contact 3 is transferred from the temporary area 802 to the main area 804 for continued display as shown in FIG. 9E, while the temporary area and associated active current contact id and active current contact width are reset.

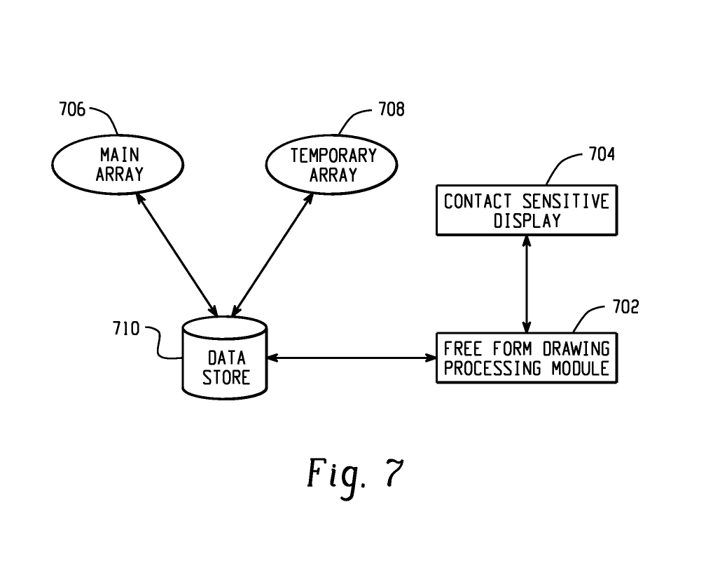

FIGS. 10A and 10B depict additional example operations associated with a method of displaying free-form drawing on a touch sensitive display. In FIG. 10A, a new current contact is depicted and assigned current contact id=4. Current contact 4 has a width of d, which is greater than the maximum width threshold. Therefore, current contact 4 is rejected. Because current contact 4 is rejected, it is not made the active current contact, the active current contact width variable is not updated, and data associated with current contact 4 is not tracked in the temporary area 802. In one example, current contact 4 is associated with a user's palm or wrist resting on the contact-sensitive display while writing with a finger or stylus. It is noted that steps described above with reference to FIGS. 8-10 are carried out by a computer and/or components of a computer (e.g., a processing system or processor of a computer), in an embodiment.

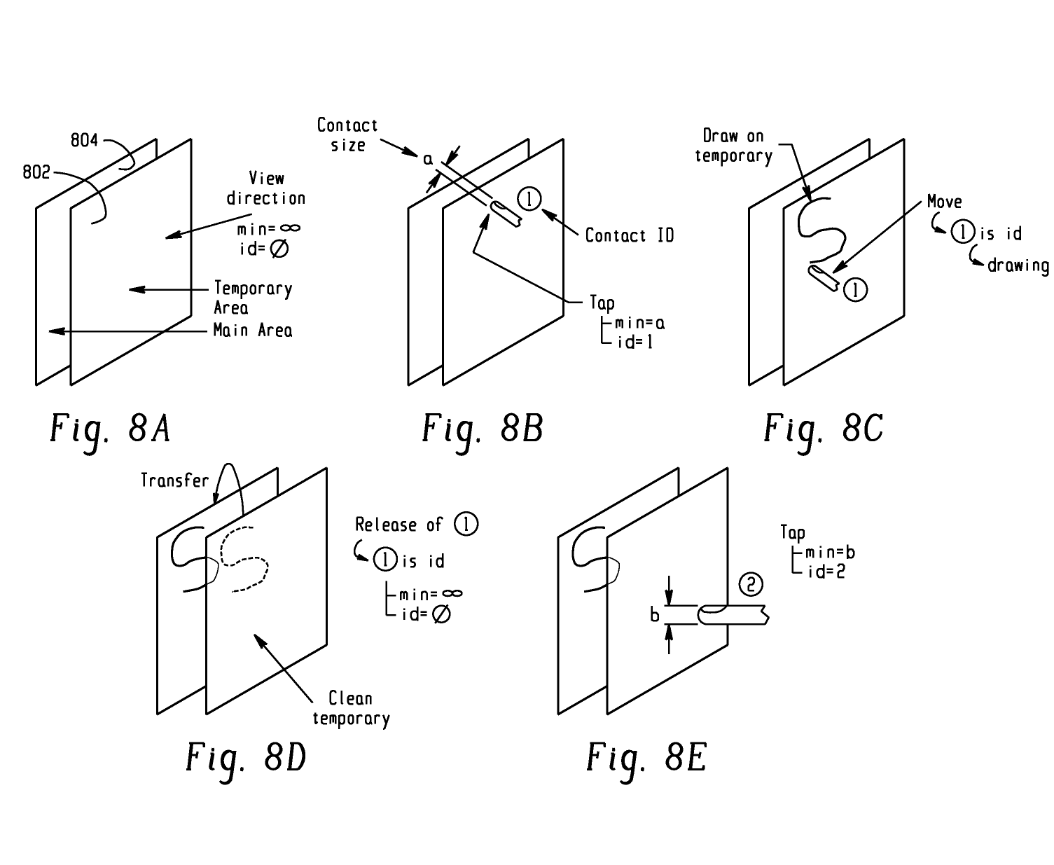

FIG. 11 is a diagram depicting an example method of displaying free-form drawing on a touch sensitive display. At 1102, a new contact is detected via a contact-sensitive display. A determination is made at 1104 as to whether a width of the new contact is less than a maximum width threshold. When it is not, at 1106, the new contact is rejected and further tracking is discontinued. If the new contact has a width less than the maximum threshold, a determination is made at 1108 as to whether other current contacts are being tracked. When no other current contacts are being tracked, the new contact is tracked at 1110 in a temporary array (e.g., a first data structure), where the temporary array data is used to display a visualization of drawing by the new contact.

When other current contacts are being tracked at 1108, a determination is made at 1112 as to whether the width of the new contact is smaller than widths of the other current contacts being tracked. When the width of the new contact is not the smallest width, then the new contact is rejected at 1114, and the new contact is no longer tracked. When the new contact has the smallest width of the current contacts, then the new contact is deemed the active current contact, and the other current contacts are rejected at 1116, with further tracking of those rejected current contacts being discontinued, and temporary array data associated with those rejected current contacts being removed from the temporary array. The new contact is then further tracked using the temporary array at 1110. When the new contact is released, and when the new contact has not previously been rejected, the new contact is deemed a desirable contact. Data associated with the new contact is transferred at 1118 from the temporary array to the main array, where data from both the temporary array and the main array are used to update a display such that the display shows free-form drawing associated with all determined desirable contacts as well as the active current contact. It is noted that steps described above with reference to FIGS. 7-11 are carried out by a computer and/or components of a computer (e.g., a processing system or processor of a computer), in an embodiment. In an example, the systems and methods described above with reference to FIGS. 7-11 are implemented in the teacher computer and/or teacher software described herein. The systems and methods of FIGS. 7-11 may also be implemented in the student tablets and/or student software described herein.

Certain systems and methods for displaying free-form drawing on a contact-sensitive display utilize sampling procedures, where coordinates associated with current contacts are sampled every n seconds (e.g., every 100 ms). When free-form drawing is being performed quickly, simply connecting-the-dots between sampled coordinates on the contact-sensitive display may result in an unnatural-looking drawing, where a series of straight lines with pointed vertices are displayed when attempting to visualize more fluid free-form drawing, such as drawing text using a finger or stylus. FIGS. 12-15 describe example operations associated with a process for smoothing visualization of free-form drawing on a contact-sensitive display. FIG. 12A depicts a detection of a start of a new current contact on a contact-sensitive display 600. A system identifies a coordinate of the start of that new current contact at time t=0, indicated at 602 in FIG. 12A. A system utilizes a sampling technique, where a second sample is taken at t=1n at a coordinate indicated in FIG. 12B at 604. A first midpoint 606 that is midway between the first point 602 and the second point 604 is identified. In one embodiment, a straight line 608 is visualized on the contact-sensitive display between the first point 602 and the first midpoint 606. In a particular embodiment, only a portion 610 of the contact-sensitive display 600 is updated to include the straight line, which may increase refresh speed and lower power utilization as compared to a full display 600 refresh.

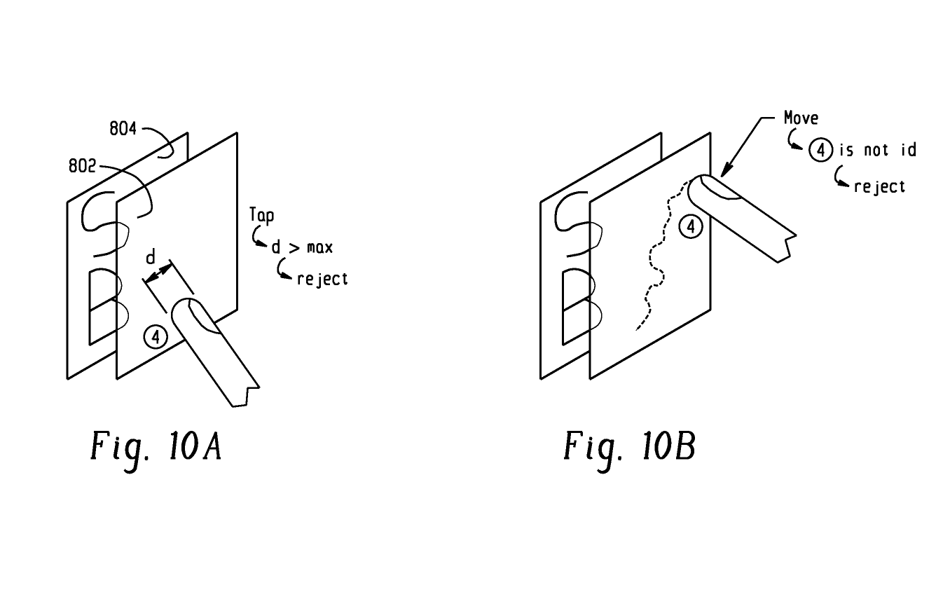

FIG. 13 depicts continued operations, where a third sample is taken at t=2n at 612. A second midpoint 614 is identified that is midway between the second point 604 and the third point 612. Directly connecting the three consecutive points 602, 604, 612 would result in the dashed lines indicated at 616. While such lines would be true to the sampled coordinates of the current contact, those lines would not appear to be associated with fluent free-form drawing, such as cursive handwriting using a finger or stylus. Thus, instead of the straight lines at 616, the systems and methods described herein determine and draw a curve 618 from the first midpoint 606 to the second midpoint 614 on the contact-sensitive display 600. In one embodiment, when displaying the determined curve, only a portion 620 represented by the dashed-line box of the contact-sensitive display 600 is refreshed, providing, in one embodiment, a near real-time depiction of free-form drawing indicated by the current contact. In one embodiment, the determined curve is a Bezier curve, in one embodiment the curve is a quadratic Bezier curve, and in one embodiment the curve is a second degree curve.

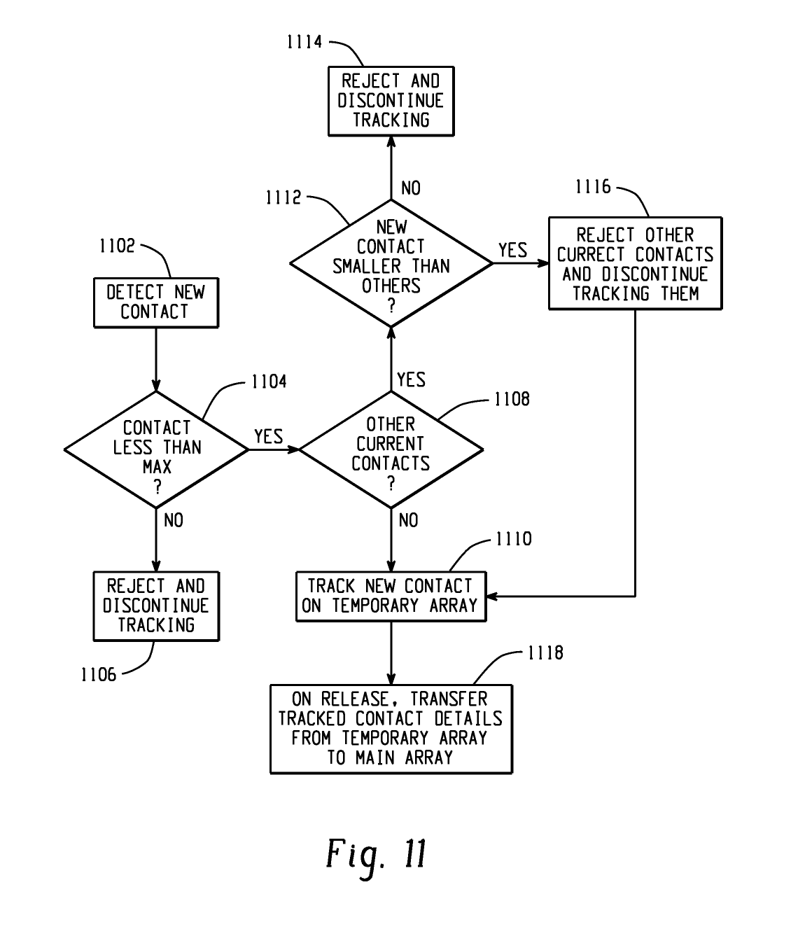

FIG. 14 depicts further operations, where a fourth sample is taken at t=3n at 622 and a fifth sample is taken at 624 when the current contact is released from the contact-sensitive display 600. A third midpoint 626 is identified that is midway between the third point 612 and the fourth point 622. A second curve 628 is determined from the second midpoint 614 and the third midpoint 626 and is drawn on the contact-sensitive display. In one embodiment, a final curve 630 is determined and drawn from the third midpoint 626 to the fifth sample coordinate at 624. In one embodiment of the disclosure, a limited portion 632 of the contact-sensitive display 600 is refreshed to depict the final curve 630.

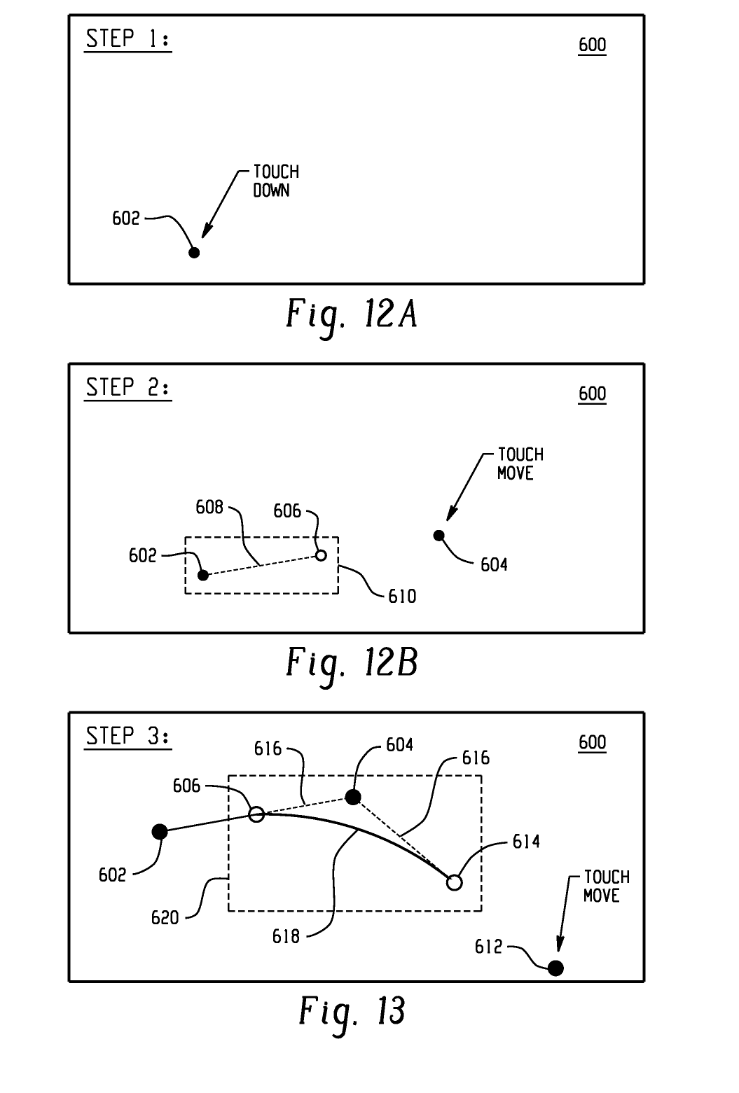

FIG. 15 is a flow diagram depicting an example process for displaying free-form drawing on a contact-sensitive display. At 902, an initial contact is detected, and a coordinate associated with that initial contact is stored. At 904, coordinates associated with further continued contact are sampled at a current time, every n seconds, until three consecutive points' coordinates are stored, with samples being taken periodically, every n seconds. At 906, a midpoint between coordinates sampled two time periods ago (at t−2n) and one time period ago (at t−n) is identified and stored as a first midpoint (P1). At 908, a midpoint between coordinates sampled one time period ago (at t−n) and in a current cycle (at t) is identified as a second midpoint (P2). At 910, a Bezier curve from the first midpoint (P1) to the second midpoint (P2) is determined, and at 912, that determined curve from the first midpoint to the second midpoint is drawn on the contact-sensitive display. The process repeats, as indicated at 914, where another coordinate at new time t is sampled at 904. It is noted that steps described above with reference to FIGS. 12-15 are carried out by a computer and/or components of a computer (e.g., a processing system or processor of a computer), in an embodiment. In an example, the systems and methods described above with reference to FIGS. 12-15 are implemented in the teacher computer and/or teacher software described herein. The systems and methods of FIGS. 12-15 may also be implemented in the student tablets and/or student software described herein.

In a further embodiment of the disclosure, systems and methods are configured to record user interactions with a contact-sensitive device so that a simulation of those interactions can be replayed to that user or a different user at a future time. For example, a system can provide a mechanism for a teacher to observe a process by which a student went about doing an exercise or solving a problem to determine a quality of that effort by the student. Additionally, a teacher can identify points in the process where the student struggled in order to provide additional instruction to the student. The systems and methods also configured for joint review of a simulated replay by the teacher and the student so that the teacher can provide enhanced feedback to the student while watching a replay of the user's interactions with the device. In one example, a system provides a replay of a student's writing on the contact-sensitive device, such as part of a handwriting quality evaluation. Such an embodiment enables evaluation of a user's writing pace, fluidity, and other writing characteristics.

FIG. 16 is a flow diagram depicting a process of capturing user interactions with a contact-sensitive device and providing a real-time simulation replay of the user interactions. At 1002, parameters of a user interaction are captured. Such interactions can include the start of a recording period, a start of a contact with a contact-sensitive device, a movement of a contact with the contact-sensitive device, and an end of a contact with the contact-sensitive device. In one embodiment, each captured user interaction includes a timestamp. At 1004, certain captured interaction parameters including a time stamp are stored, such as in a non-transitory data store for subsequent access. The process of capturing user interaction parameters and storing those parameters is repeated for subsequent user interactions during the recording session. In one example, a set of user interactions includes a start recording interaction, a contact start (press) interaction, a series of contact move interactions, a contact end (release) operation, and an end recording interaction.

At 1006, stored captured interaction parameters are accessed from the data store, such as via a request to display a simulation of the user interactions. The stored captured interaction parameters associated with the user sessions for which a person wishes to view a simulation are accessed from the data store and are used to provide, at 1008, a simulation of the user interactions. In one embodiment, the simulation of the user interaction is provided in a real time fashion, where the speed of the interactions in the simulation matches the speed of user interactions during capture. In an embodiment, the simulation can be provided in slow motion or fast motion, stopped, and paused. In one embodiment, the simulation can be requested and played on a device that is different from a device that included the contact-sensitive device with which the user interactions were captured. In an example, a student tablet captures the user interactions, and the simulation is played on a teacher computer.

Data of a recording file that stores data associated with detected user interactions includes the following, in an example:

# protocol_version: 2
# resolution_width: 1280
# resolution_height: 752 //
2 25 8
2 28 0 0 255 255
3 18 1
169 26
476 26
4211 1 647 316
4269 0 648 315
4269 0 648 316
4286 0 648 317
4303 0 648 319
4304 0 648 321
4305 0 648 323
4320 0 648 326
4320 0 648 330
4336 0 648 334
4336 2 648 339

Such a recording file is generated during a recording session where a user interacts with a contact-sensitive device. Each line of the file is associated with a captured interaction. A first value in a line indicates a time stamp (e.g., in milliseconds) of the detected user interaction. A second value indicates a type of interaction associated with the line (e.g., a contact start operation, a contact movement interaction, a start recording operation). Subsequent parameters in a line, in one embodiment, identify further parameters associated with the interaction.

In one embodiment, the number and value of the further parameters are dictated by the type of interaction.

For example, a contact start interaction (code 0) in one embodiment is followed by an x-coordinate parameter and a y-coordinate parameter. In an embodiment, an erase operation (code 26) deletes a last added drawing on a screen (e.g., a last drawing operation on an operation stack) and includes zero additional parameters.

A commented version of the recording file described above includes the following, in an example:

// the lines beginning by a # are relating to configuration.
#protocol_version: 2 // Version of the replay protocol.
#resolution_width: 1280 // X Resolution of the screen in pixels.
#resolution_height: 752 //Y resolution of the screen in pixels.
*/each line without # is an action recorded. The first number is the
time line event in millisecond. The second is the type of event (see
below correspondence table). The instructions after are relating to
the type of event (coordinates on the screen, color selected, size of
the pencil. See comments on each line for examples. In any case each
line needs at least to have two instruction: the time line and the
type of event. */
2 25 8 // 2 [milliseconds] 25 [the event: size selection of the
pencil] 8 [the selected size of the pencil]
2 28 0 0 255 255 // 2 [milliseconds] 28 [the event: rgba color
selection] 0 [Red] 0 [Green] 255 [blue] 255 [Alpha].
3 18 1 //3 [milliseconds] 18 [the event: change page] 1 [Page
selected].
169 26 // 169 [milliseconds] 26 [the event: erase all the page].
476 26 // 476 [milliseconds] 26 [the event: erase all the page].
4211 1 647 316 // 4211 [milliseconds] 1 [the event: pen down] 647 [X
coordinates of the pen down] 316 [y coordinates of the pen down]
4236 0 648 315 // 4236 [milliseconds] 0 [the event: movement] 648 [X
coordinates of sampled movement] 315 [y coordinates of sampled
movement]
4269 0 648 316 // 4269 [milliseconds] 0 [the event: movement] 648 [X
coordinates of sampled movement] 316 [y coordinates of sampled
movement]
4286 0 648 317 // 4286 [milliseconds] 0 [the event: movement] 648 [X
coordinates of sampled movement] 317 [y coordinates of sampled
movement]
4303 0 64 319 // . . .
4304 0 648 321
4305 0 648 323
4320 0 648 326
4320 0 648 330
4336 0 648 334

In the commented recording file shown above, a first record (row) identifies an operation at time=2 ms where the user selects a size 8 pencil using the contact-sensitive display. A second record is also associated with time=2 ms where the user commands the pencil to be blue. A third record at time=3 ms indicates that the user selected page 1. Fourth and fifth records indicate erase operations. A sixth record associated with time=4211 ms is associated with a contact start operation at the coordinates (647, 316). A next record indicates the contact movement interaction where the contact moves to (648, 315). The following record indicates the contact movement interaction where the contact moves to (648, 316). Subsequent records indicate a time stamp and coordinates associated with subsequent contact movements. In one embodiment, to provide a simulation replay of the user interactions, a clock is started and a next row of a recording file is accessed. When the time stamp of the recording file row matches the clock time, the interaction represented by the remainder of the row is simulated (e.g., continuing drawing of a free-form (smoothed) line) and a next row of the recording file is accessed.

Interaction type codes for a plurality of different interaction types include the following, in an example:

// List of different types of instructions.
// Press = 1
// Release = 2
// Move = 0
// Close = 10
// Finish = 11
// Previous = 12
// Back = 13
// Next = 14
// Forward = 15
// Fullscreen = 16
// Zoom = 17
// Page = 18
// Landscape = 19
// Portrait = 20
// Size = 25
// Erase = 26
// Save = 27
// Rgba = 28
// Scroll = 29
// Pdf previous = 30
// Pdf next = 31
// Pdf position = 32
// Play = 100
// Speed = 101
// Set = 102
// Pause = 103
// Start = 200

Each of the depicted interaction types is associated with zero or more additional parameters as part of a row in a recording file.

In providing a simulation display of recorded user interactions, a recording file like the one described above is accessed. Each row of the file is read, and the user interactions are simulated at the time stamps indicated at the first value of each row. For example, certain user interface controls depicted in the simulation may be highlighted at a rate that the user selected those controls (e.g., to select a pencil size and color). Further, a depicting of a contact associated with the user writing on the contact-sensitive display is simulated via a line that begins at the time and coordinate of the contact start operation, extending through (or near) each of the coordinates indicated by contact movement rows, until the line ends at a time and coordinate associated with a contact end row in the recording file.

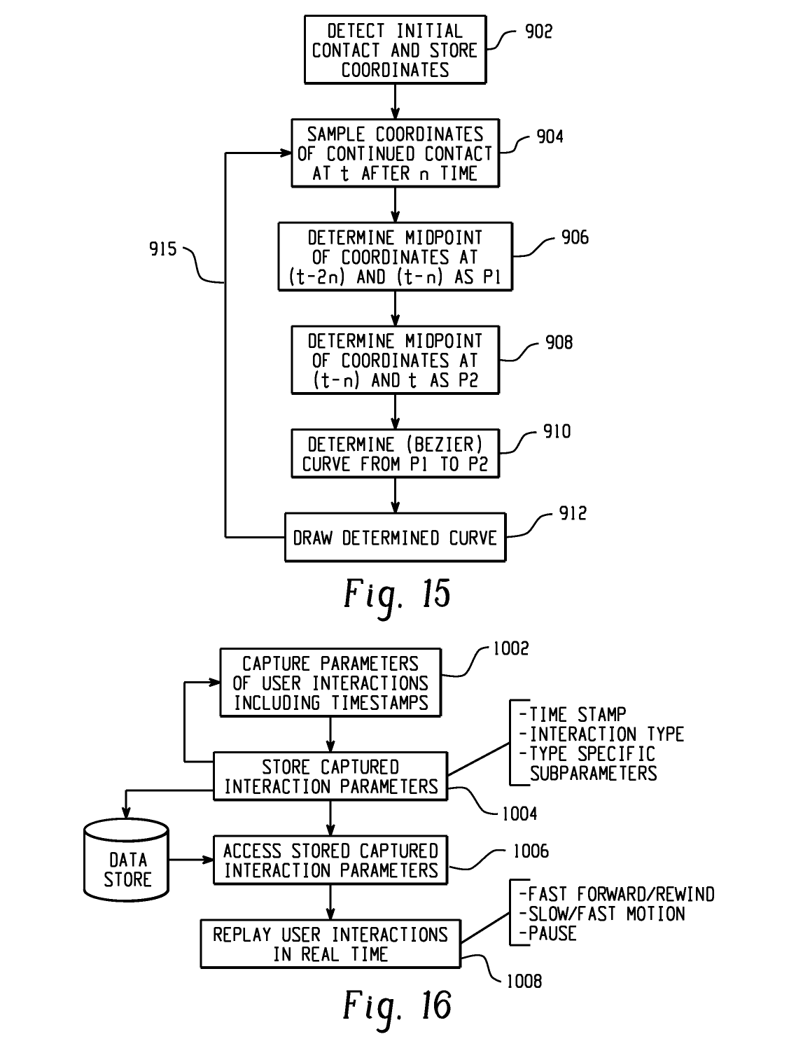

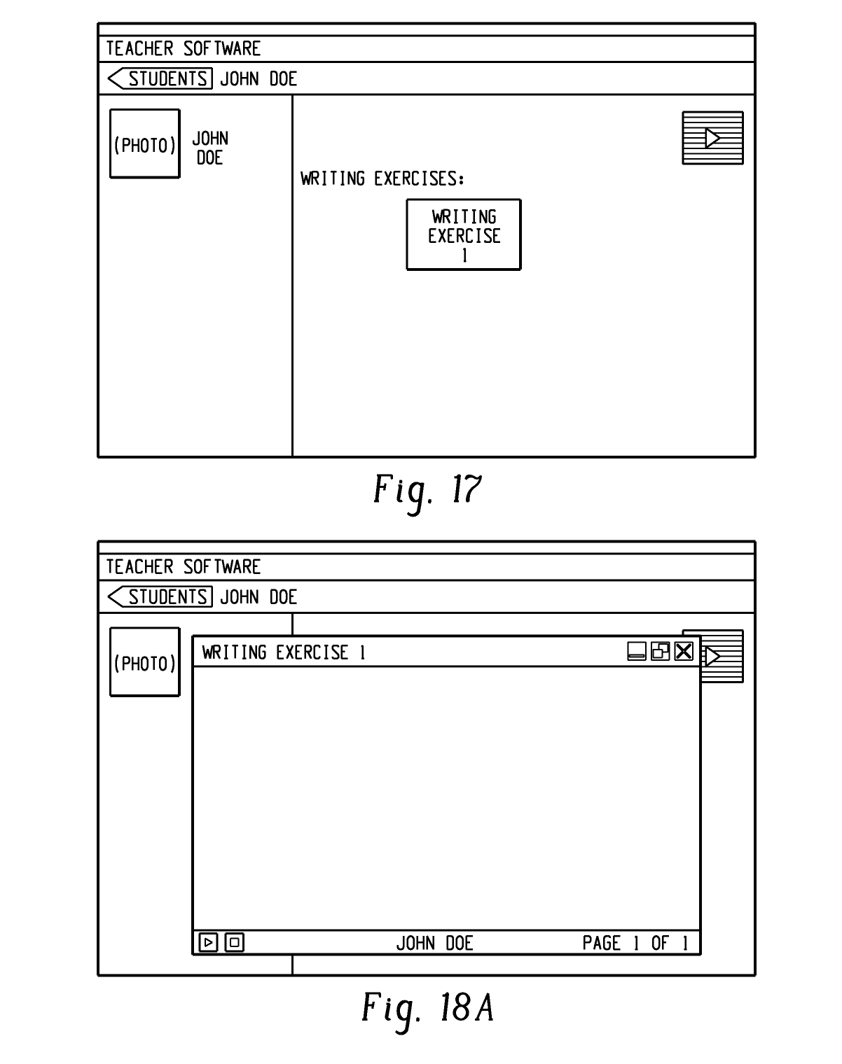

FIG. 17 is a diagram depicting a graphical user interface for selecting an interaction capture session for viewing. A central portion of the user interface provides indications of any captured sessions that are available for viewing. In one embodiment, an actual or simulated screenshot (e.g., of a student's handwriting at a point during the capture session) is provided on the selection screen. FIGS. 18A and 18B are diagrams depicting user interfaces for viewing a simulation of the user interactions. In the example of FIGS. 18A and 18B, the simulation is provided via a pop-up window. The window includes a play and stop button when the simulation is not running, a pause and a stop button when the simulation is running, and a close window button.

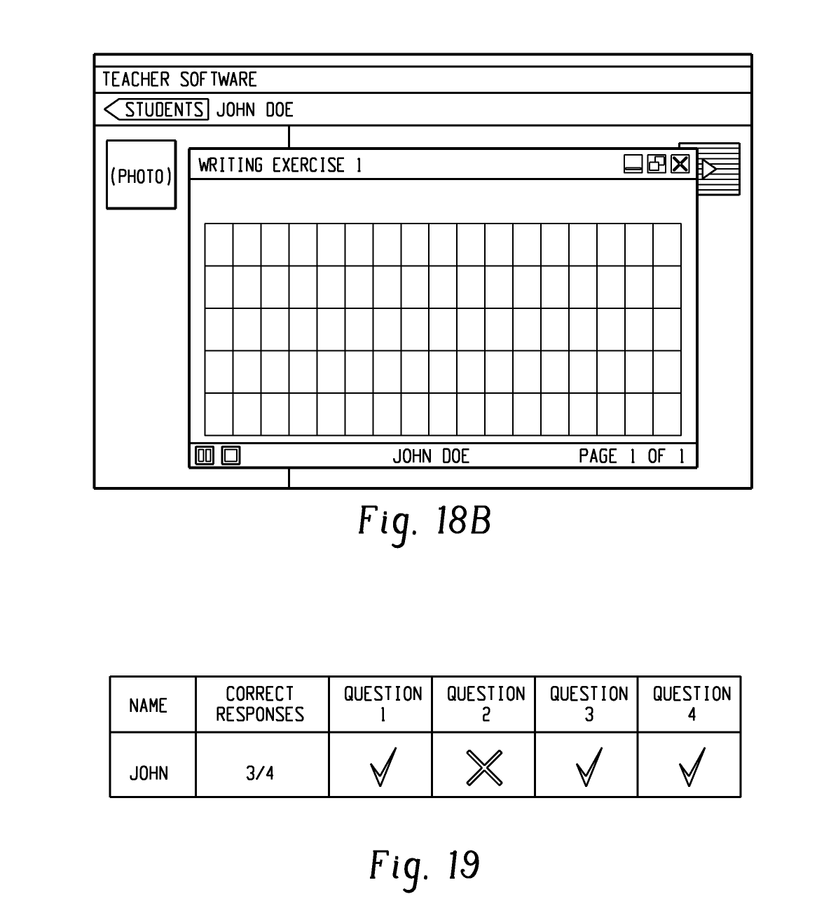

FIG. 19 is a diagram depicting a graphical user interface that provides correctness indications for different user activities. In a system where interaction capture is performed during a show-your-work type activity, a user's performance can be better analyzed. For example, it may be desirable for an instructor to focus their review on questions that a student performed incorrectly (got wrong). By watching a simulated replay of the user's performance on the activity, the instructor can pinpoint where the student struggled (e.g., via long pauses) and where a student erred from a proper technique. Without a simulated replay as described herein, it is not possible to see the order in which the student took notes during the show-your-work activity. The graphical user interface of FIG. 19 indicates which questions a student got right and wrong (e.g., via automated scoring), where clicking on the “X” indicating a wrong answer commands display of a simulated replay of student interactions on that problem. It is noted that steps described above with reference to FIGS. 16-19 are carried out by a computer and/or components of a computer (e.g., a processing system or processor of a computer), in an embodiment. In an example, the systems and methods described above with reference to FIGS. 16-19 are implemented in the teacher computer and/or teacher software described herein. The systems and methods of FIGS. 16-19 may also be implemented in the student tablets and/or student software described herein.

This written description uses examples to disclose the invention, including the best mode, and also to enable a person skilled in the art to make and use the invention. The patentable scope of the invention includes other examples. Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Further, as used in the description herein and throughout the claims that follow, the meaning of “each” does not require “each and every” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive of” may be used to indicate situations where only the disjunctive meaning may apply.

It is claimed:

1. A computer-implemented method of displaying free-form drawing on a contact-sensitive display, comprising:
detecting, by the computer, a new contact on the contact-sensitive display;
determining, by the computer, whether a width of the new contact is less than a maximum width threshold;
when the width of the new contact is less than the maximum width threshold, comparing, by the computer, the width of the new contact to a width of other current contacts;
when the width of the new contact is less than widths of all other current contacts, tracking, by the computer, the new contact using a first data structure;
detecting, by the computer, a release of the new contact from the contact-sensitive display; and
transferring, by the computer, data associated with the new contact from the first data structure to the second data structure when the computer detects that the new contact has been released, wherein contact data stored in the first data structure and the second data structure are used to visualize drawing on the contact-sensitive display.

2. The method of claim 1, further comprising:
when the width of the new contact is not less than the maximum width threshold, declining, by the computer, to further track the new contact using the first data structure.

3. The method of claim 1, further comprising:
when the width of the new contact is not less than widths of all the other current contacts, declining, by the computer, to further track the new contact using the first data structure.

4. The method of claim 1, further comprising:
when the width of the new contact is less than a width of a particular current contact:
declining, by the computer, to further track the particular current contact using the first data structure, and
removing, by the computer, tracking data associated with the particular current contact from the first data structure.

5. The method of claim 4, wherein removing comprises deleting or marking invalid.

6. The method of claim 4, further comprising:
updating, by the computer, the contact-sensitive display to remove visualization of the particular current contact when the tracking data associated with the particular current contact is removed.

7. The method of claim 1, further comprising:
when comparing the width of the new contact to the width of other current contacts identifies no other current contacts, tracking, by the computer, the new current contact using the first data structure.

8. The method of claim 1, wherein the contact-sensitive display is a component of a cellular telephone, a smart phone, a tablet device, a laptop, or a combination thereof.

9. The method of claim 1, wherein the first data structure is a first array for tracking unconfirmed contacts, and wherein the second data structure is a second array for tracking confirmed contacts.

10. The method of claim 1, wherein the contact-sensitive display is configured to detect multiple contacts simultaneously.

11. The method of claim 1, wherein the contact-sensitive display is configured to detect contacts from a contact or a stylus.

12. The method of claim 1, further comprising:
removing, by the computer, transferred data associated with the new contact from the first data structure after transferring.

13. The method of claim 2, wherein the new contact is contact by a palm of a person.

14. A system for displaying free-form drawing on a contact-sensitive display, comprising:
a contact-sensitive display configured to detect multiple contacts simultaneously;
a first data structure stored on a non-transitory computer-readable medium configured to store tracking data associated with unconfirmed contacts;
a second data structure stored on the non-transitory computer-readable medium configured to store tracking data associated with confirmed contacts; and
a processing system configured to determine whether a new contact on the contact-sensitive display is a highest priority contact;
wherein when the new contact is determined by the processing system to be the highest priority contact, tracking data associated with the new contact is stored in the first data structure by the processing system and tracking data associated with other contacts is removed from the first data structure by the processing system;
wherein when the new contact is released and remains the highest priority contact, the tracking data associated with the new contact is copied to the second data structure by the processing system;
wherein the contact-sensitive display is configured to visualize data stored in both the first data structure and the second data structure simultaneously.

15. A system for displaying free-form drawing on a contact-sensitive display, comprising:
a contact-sensitive display configured to detect multiple contacts simultaneously;
a first data structure stored on a non-transitory computer-readable medium configured to store tracking data associated with unconfirmed contacts;
a second data structure stored on the non-transitory computer-readable medium configured to store tracking data associated with confirmed contacts; and
a processing system configured to execute steps comprising:
determining whether a width of a new contact is less than a maximum width threshold;
when the width of the new contact is less than the maximum width threshold, comparing the width of the new contact to a width of other current contacts;
when the width of the new contact is less than widths of all other current contacts, tracking the new contact using a first data structure;
detecting a release of the new contact from the contact-sensitive display;
transferring data associated with the new contact from the first data structure to the second data structure when the new contact is detected to have been released, wherein contact data stored in the first data structure and the second data structure are used to visualize drawing on the contact-sensitive display.

16. The system of claim 15, wherein the steps performed by the processing system include:
when the width of the new contact is not less than the maximum width threshold, declining to further track the new contact using the first data structure.

17. The system of claim 15, wherein the steps performed by the processing system include:
when the width of the new contact is not less than widths of all the other current contacts, declining to further track the new contact using the first data structure.

18. The system of claim 15, wherein the steps performed by the processing system include:
when the width of the new contact is less than a width of a particular current contact:
declining to further track the particular current contact using the first data structure, and
removing tracking data associated with the particular current contact from the first data structure.

19. The system of claim 18, wherein the steps performed by the processing system include:
updating the contact-sensitive display to remove visualization of the particular current contact when the tracking data associated with the particular current contact is removed.

20. The system of claim 15, wherein the steps performed by the processing system include:
when comparing the width of the new contact to the width of other current contacts identifies no other current contacts, tracking the new current contact using the first data structure.
